(19) United States
(12) Patent Application Publication
(10) Pub. No.: US 2025/0190520 A1
(43) Pub. Date: Jun. 12, 2025

(54) MATRIX MULTIPLICATION DEVICE AND MATRIX MULTIPLICATION SYSTEM INCLUDING THEREOF, AND OPERATION METHOD OF THE MATRIX MULTIPLICATION SYSTEM

(71) Applicant: SAMSUNG ELECTRONICS CO., LTD., Suwon-si (KR)

(72) Inventors: Hyun Jae Oh, Suwon-si (KR); Hong Rak Son, Suwon-si (KR); Jae Hun Jang, Suwon-si (KR); Younho Jeon, Suwon-si (KR)

(73) Assignee: SAMSUNG ELECTRONICS CO., LTD., Suwon-si (KR)

(21) Appl. No.: 18/787,425

(22) Filed: Jul. 29, 2024

(30) Foreign Application Priority Data
Dec. 7, 2023 (KR) 10-2023-0177028

(51) Int. Cl. G06F 17/16

(52) U.S. Cl. CPC G06F 17/16

(57) ABSTRACT

A matrix multiplication device including a weight memory circuit, an input matrix buffer, a first processing element array and a second processing element array is provided. The weight memory circuit stores a first pruned sub-matrix and a second pruned sub-matrix. The input matrix buffer receives an input matrix including a plurality of input elements, outputs a first plurality of input elements corresponding to a first plurality of residual weights of the first pruned sub-matrix, and outputs a second plurality of input elements corresponding to a second plurality of residual weights of the second pruned sub-matrix. The first processing element array receives the first plurality of residual weights and the first plurality of input elements, and outputs a first sub-output matrix. The second processing element array receives the second plurality of residual weights and the second plurality of input elements, and output a second sub-output matrix.

### CROSS-REFERENCE TO RELATED APPLICATION

This application is based on and claims priority to Korean Patent Application No. 10-2023-0177028 filed in the Korean Intellectual Property Office on Dec. 7, 2023, the entire contents of which are incorporated herein by reference.

### BACKGROUND

### 1. Field

Aspects of the disclosure relate to a semiconductor device, and in particular, to a matrix multiplication device, a matrix multiplication system, and a matrix multiplication method for performing matrix multiplication.

### 2. Description of the Related Art

As artificial intelligence technology has recently developed, a computational amount of an artificial intelligence model is rapidly increasing. Accordingly, various technologies are being researched to shorten operation time of the artificial intelligence model.

Generally, most of an operation time of the artificial intelligence model is spent on matrix multiplication. For example, the artificial intelligence model spends most portion of operation time to calculate an output matrix by performing multiplication of an input matrix and a weight matrix. Accordingly, various algorithms such as pruning and the like are being researched to perform multiplication of the input matrix and the weight matrix with less calculation amount.

### SUMMARY

Aspects of the disclosure may solve the above-described technical problem and/or other technical problems. For example, one or more aspects of the disclosure provide a matrix multiplier and a matrix multiplication device including the same, which are configured to perform matrix multiplication with a faster speed, a smaller computation amount and/or reduced resources.

According to an aspect of the disclosure, there is provided a matrix multiplication device including: a weight memory circuit configured to store a first pruned sub-matrix including a first plurality of residual weights and a second pruned sub-matrix including a second plurality of residual weights; an input matrix buffer configured to: receive an input matrix including a plurality of input elements, output a first plurality of input elements among the plurality of input elements, corresponding to the first plurality of residual weights, and output a second plurality of input elements among the plurality of input elements, corresponding to the second plurality of residual weights; a first processing element array configured to: receive the first plurality of residual weights and the first plurality of input elements, and output a first sub-output matrix; and a second processing element array configured to: receive the second plurality of residual weights and the second plurality of input elements, and output a second sub-output matrix.

According to another aspect of the disclosure, there is provided a matrix multiplication system including: a matrix pruning device generating a first plurality of pruned sub-matrices and a second plurality of pruned sub-matrices based on a weight matrix; and a matrix multiplication device including: a first processing element array configured to generate a first plurality of sub-output matrices based on an input matrix and the first plurality of pruned sub-matrices, a second processing element array configured to generate a second plurality of sub-output matrices based on the input matrix and the second plurality of pruned sub-matrices, and an output merging circuit configured to generate an output matrix based on the first plurality of sub-output matrices and the second plurality of sub-output matrices.

According to another aspect of the disclosure, there is provided an operation method of a matrix multiplication device including: generating a plurality of pruning groups by splitting a weight matrix; classifying the plurality of pruning groups as a first plurality of pruning groups and a second plurality of pruning groups based on group importance of each of the plurality of pruning groups; generating a first plurality of sub-matrices based on the first plurality of pruning groups; generating a second plurality of sub-matrices based on the second plurality of pruning groups; generating a first plurality of pruned sub-matrices by pruning each of the first plurality of sub-matrices; generating a second plurality of pruned sub-matrices by pruning each of the second plurality of sub-matrices; and generating an output matrix based on products of an input matrix and each of the first plurality of pruned sub-matrices and the second plurality of pruned sub-matrices.

### BRIEF DESCRIPTION OF DRAWINGS

The above and other aspects, features, and advantages of the disclosure will be more clearly understood from the following detailed description, taken in conjunction with the accompanying drawings, in which:

FIG. 1 is a block diagram of a matrix multiplication system according to an embodiment of the disclosure.

FIG. 2 illustrates the operation of the matrix multiplication system implemented to directly multiply the weight matrix and the input matrix of FIG. 1.

FIGS. 3, 4 and 5 are diagrams illustrating the operation of the matrix pruning device of FIG. 1.

FIG. 6 is a block diagram illustrating a matrix multiplication device of FIG. 1 in detail.

FIG. 7 is a table illustrating a residual weight index and a residual weight stored in the weight memory circuit of FIG. 6 according to an embodiment of the disclosure.

FIGS. 8, 9, 10, 11 and 12 are block diagrams illustrating the operation of some configuration of FIG. 6 in detail.

FIG. 13 illustrates the operation of the output merging circuit of FIG. 6.

FIG. 14 is a flowchart of an operation method of the matrix multiplication system according to the embodiment of the disclosure.

FIG. 15 is a flowchart illustrating the operation S200 of FIG. 14 in more detail.

FIG. 16 is a flowchart illustrating the operation S300 of FIG. 14 in more detail.

FIG. 17 is a flowchart illustrating the operation S310 of FIG. 16 in more detail.

FIG. 18 is a flowchart illustrating the operation S320 of FIG. 16 in more detail.

FIG. 19 illustrates the iterative operation of the processing element arrays of FIG. 6.

FIG. 20 is a block diagram illustrating the processing element array of FIG. 19 using a systolic array method.

FIG. 21 illustrates the configuration of the processing element of FIG. 20 in more detail

FIG. 22 is a timing diagram illustrating the operation of each of the processing elements of FIG. 20.

FIG. 23 illustrates a method for adjusting the operation time of the processing element arrays of FIG. 19 according to an embodiment.

FIG. 24 illustrates a method for adjusting the operation time of the processing element arrays of FIG. 19 according to an embodiment.

FIG. 25 is a flowchart of a method for synchronizing the operation time of the processing element arrays of FIG. 19.

FIGS. 26 and 27 illustrate an operation of a matrix pruning device according to another embodiment.

FIG. 28 is a block diagram of a matrix multiplication system according to an embodiment.

FIG. 29 illustrates the operation of the matrix pruning device of FIG. 28.

FIG. 30 is a block diagram illustrating the matrix multiplication device of FIG. 28 in more detail.

FIG. 31 illustrates the matrix multiplication system of FIG. 1 according to an embodiment.

FIG. 32 illustrates the full-input matrix of FIG. 31.

FIG. 33 illustrates the full-weight matrix of FIG. 31.

FIG. 34 illustrates the full-output matrix of FIG. 31.

FIG. 35 is a block diagram of a neural processing system implemented according to an embodiment.

FIG. 36 is a block diagram of the artificial intelligence model run by the neural processing system of FIG. 35.

### DETAILED DESCRIPTION

Below, embodiments of the disclosure will be described clearly and in detail to such an extent that a person of an ordinary skill in the technical field of the disclosure may easily perform the disclosure. Details such as detailed configurations and structures are provided simply to facilitate an overall understanding of the embodiments of the disclosure. Therefore, modifications of the embodiments described in the disclosure may be performed by a person of an ordinary skill in the art without departing from the technical spirit and scope of the disclosure. Moreover, descriptions of well-known functions and structures are omitted for clarity and brevity. Configurations in the drawings or a detailed description of the disclosure may be connected to an element other than that shown in the drawings or described in the detailed description. Terms used in the disclosure are defined considering functions of the disclosure, and are not limited to specific functions. The definition of the terms may be determined based on details described in the detailed description.

Elements described with reference to a term such as a driver, a block, or the like used in the detailed description may be implemented in the form of software, hardware, or a combination thereof. For example, the software may be a machine code, firmware, an embedded code, and application software. For example, the hardware may include an electrical circuit, an electronic circuit, a processor, a computer, integrated circuit cores, a pressure sensor, an inertial sensor, a microelectromechanical System (MEMS), a passive element, or a combination thereof.

The features described herein may be implemented in different forms and should not be construed as being limited to examples described herein. Rather, the examples described herein have been provided to illustrate only some of many feasible ways of realizing the methods, devices, and/or systems described herein, many feasible ways will be clear upon an understanding of the disclosure of the present application.

The terms used herein are used only to describe various examples and will not be used to limit the disclosure. Unless the context clearly indicates otherwise, the singular form is also intended to include the plural form. The terms “comprising,” “including,” and “having” indicate the presence of recited features, quantities, operations, components, elements, and/or combinations thereof, but do not preclude the presence or addition of one or more other features, quantities, operations, components, elements, and/or combinations thereof.

Unless otherwise defined, all terms used herein, including technical and scientific terms, have the same meanings as those commonly understood by those of ordinary skill in the art to which the disclosure pertains after understanding the disclosure. Unless expressly so defined herein, terms (e.g., terms defined in a general-purpose dictionary) should be interpreted as having a meaning consistent with their meaning in the context of the relevant field and the disclosure, and should not be interpreted ideally or in an overly formalistic manner.

Unless otherwise defined, all terms, including technical and scientific terms, used herein have the same meaning as commonly understood by one of ordinary skill in the art to which this disclosure pertains and based on an understanding of the disclosure of the present application. Terms, such as those defined in commonly used dictionaries, are to be interpreted as having a meaning that is consistent with their meaning in the context of the relevant art and the disclosure of the present application and are not to be interpreted in an idealized or overly formal sense unless expressly so defined herein. The use of the term “may” herein with respect to an example or embodiment (e.g., as to what an example or embodiment may include or implement) means that at least one example or embodiment exists where such a feature is included or implemented, while all example embodiments are not limited thereto.

Hereinafter, for a more concise description, a matrix is referred to through square brackets “[” and “]”. However, a scope of the disclosure is not limited to the notation method.

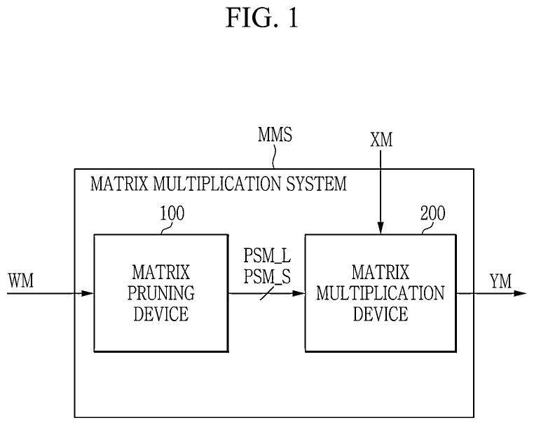

FIG. 1 is a block diagram of a matrix multiplication system according to an embodiment of the disclosure. Referring to FIG. 1, a matrix multiplication system MMS may include a matrix pruning device 100 and a matrix multiplication device 200.

In an embodiment, the matrix multiplication system MMS may be used in driving an artificial intelligence model. For example, the matrix multiplication system MMS may be used to perform matrix multiplication operations required to execute an artificial intelligence model. However, the scope of the disclosure is not limited to a specific embodiment in which the matrix multiplication system MMS is used, and as such, according to another embodiment, the matrix multiplication system MMS may be used to implement or execute other operations, processes and functions.

The matrix pruning device 100 may receive a weight matrix WM. The weight matrix WM may include a plurality of weights. For example, the weight matrix WM may be represented as given in Equation 1.

$$WM = [ \begin{matrix}{w}_{11} & {w}_{12} & … & {w}_{1 m} \\ {w}_{21} & {w}_{22} & … & {w}_{2 m} \\ ⋮ & ⋮ & ⋱ & ⋮ \\ {w}_{n 1} & {w}_{n 2} & … & {w}_{n m}\end{matrix} ] \qquad ( Equation 1 )$$

Referring to Equation 1, WM may denote a weight matrix WM, w₁₁ to wₙₘ may respectively represent different weights. For example, wᵢⱼ may be a weight provided in an i-th row and a j-th column of the weight matrix WM.

Hereinafter, an embodiment in which the weight matrix WM includes “n” weight rows and “m” weight columns will be representatively described, where n and m are integers.

In an embodiment, each of the weights included in the weight matrix WM may have a floating point data type. However, the scope of disclosure is not limited thereto, and as such, according to another embodiment, the weights included in the weight matrix WM may have another data type.

The matrix pruning device 100 may generate a plurality of pruned small sub-matrices PSM_S and a plurality of pruned large sub-matrices PSM_L based on the weight matrix WM. For example, the matrix pruning device 100 may generate the plurality of pruned small sub-matrices PSM_S by pruning a small sub-matrix (hereinafter, referred to as SM_S) corresponding to a part of the weight matrix WM, and may generate the plurality of pruned large sub-matrices PSM_L by pruning a large sub-matrix (hereinafter, referred to as SM_L) corresponding to another part of the weight matrix WM. For example, the small sub-matrix corresponds to a first part of the weight matrix WM, and the large sub-matrix corresponds to a second part of the weight matrix WM.

According to an embodiment, the matrix pruning device 100 may generate the plurality of pruned small sub-matrices PSM_S by changing some of weights included in the small sub-matrix SM_S to zero element (e.g., “0”), and may generate the plurality of pruned large sub-matrices PSM_L by changing some of weights included in the large sub-matrix SM_L to zero element. For example, the matrix pruning device 100 may generate the plurality of pruned small sub-matrices PSM_S by changing one or more of weights included in the small sub-matrix SM_S to zero element (i.e., “0”), and may generate the plurality of pruned large sub-matrices PSM_L by changing one or more of weights included in the large sub-matrix SM_L to zero element.

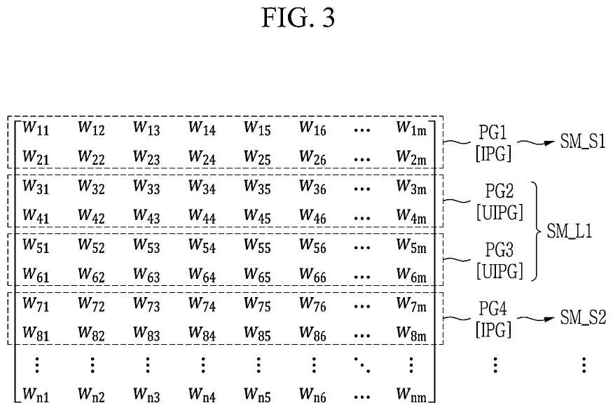

According to an embodiment, the matrix pruning device 100 may approximate the weight matrix WM based on the plurality of pruned small sub-matrices PSM_S and the plurality of pruned large sub-matrices PSM_L. In this case, a plurality of zero elements may be included in the plurality of pruned small sub-matrices PSM_S and the plurality of pruned large sub-matrices PSM_L. Accordingly, in an example case in which a matrix multiplication operation for the weight matrix WM is performed based on the plurality of pruned small sub-matrices PSM_S and the plurality of pruned large sub-matrices PSM_L, the amount of operations required for matrix multiplication operations can be reduced. The operation of the matrix pruning device 100 will be described in more detail with reference to FIGS. 3, 4, and 5.

In an embodiment, the matrix pruning device 100 may be used in training of an artificial intelligence (AI) model executed based on the matrix multiplication system MMS. For example, while the AI model being trained, the matrix pruning device 100 may be implemented to generate the plurality of pruned small sub-matrices PSM_S and the plurality of pruned large sub-matrices PSM_L. However, the scope of the disclosure is not limited to a detailed embodiment in which the matrix pruning device 100 is used. As such, according to another embodiment, the matrix pruning device 100 may be implemented to perform other operations, processes and/or functions related to various other types of tasks.

The matrix multiplication device 200 may receive an input matrix XM. The input matrix XM may include a first to m-th input element row (hereinafter, referred to as IER) and a first to b-th input element column (hereinafter, referred to as IEC), where b is an integer. Each of the first to m-th input element rows may include a plurality of input elements. For example, the input matrix XM may be expressed as given in Equation 2.

$$XM = [ \begin{matrix}{x}_{11} & {x}_{12} & … & {x}_{1 b} \\ {x}_{21} & {x}_{22} & … & {x}_{2 b} \\ ⋮ & ⋮ & ⋱ & ⋮ \\ {x}_{m 1} & {x}_{m 2} & … & {x}_{mb}\end{matrix} ] \qquad ( Equation 2 )$$

Referring to Equation 2, XM may denote an input matrix XM, and x₁₁ to X_{mb} may denote different input elements. For example, x₁₁ to x_{1b} may denote input elements included in the first input element row of the input matrix XM and xₘ₁ to x_{mb} may denote input elements included in the m-th input element row.

Hereinafter, an embodiment in which the input matrix XM includes m input element rows and b input element columns will be representatively described.

In an embodiment, each input element included in the input matrix XM may have a floating point data type. However, the scope of disclosure is not limited thereto, and as such, according to another embodiment, the weights included in the weight matrix WM may have another data type.

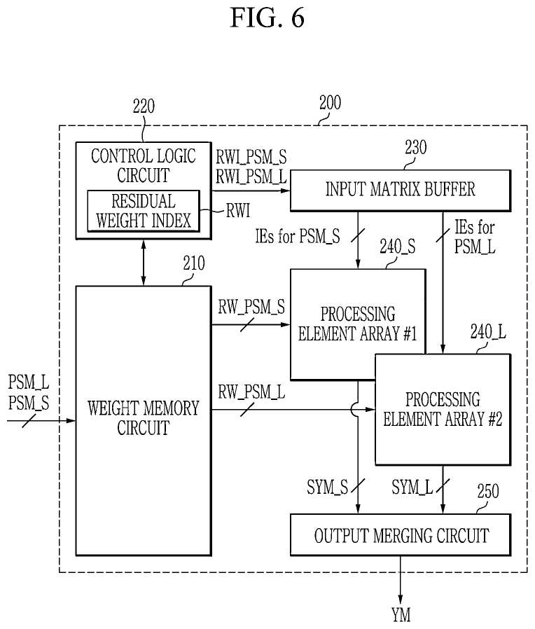

The matrix multiplication device 200 may receive the plurality of pruned small sub-matrices PSM_S and the plurality of pruned large sub-matrices PSM_L from the matrix pruning device 100. The matrix multiplication device 200 may generate an output matrix YM based on the multiplication of the input matrix XM for each of the plurality of pruned small sub-matrices PSM_S and the plurality of pruned large sub-matrices PSM_L. For example, the matrix multiplication device 200 may generate an output matrix YM by merging the results of multiplication to each of the plurality of pruned small sub-matrices PSM_S and the plurality of pruned large sub-matrices PSM_L. A more detailed configuration and operation of the matrix multiplication device 200 will be described in more detail with reference to FIG. 6 to FIG. 13.

In an embodiment, the matrix multiplication device 200 may be used in inferencing of the AI model executed based on the matrix multiplication system MMS. For example, while the AI performing the inference operation, the matrix multiplication device 200 may be implemented to generate an output matrix YM based on the input matrix XM, the plurality of pruned small sub-matrices PSM_S, and the plurality of pruned large sub-matrices PSM_L. However, the scope of the disclosure is not limited to the specific embodiment in which the matrix multiplication device 200 is used.

The output matrix YM may include a plurality of output elements. The output matrix YM may include a first to n-th output element row (hereinafter, referred to as OER). Each of the first to n-th output element row may include a plurality of output elements. For example, the output matrix YM may be expressed as given in Equation 3.

$$YM = [ \begin{matrix}{y}_{11} & {y}_{12} & … & {y}_{1 b} \\ {y}_{21} & {y}_{22} & … & {y}_{2 b} \\ ⋮ & ⋮ & ⋱ & ⋮ \\ {y}_{n 1} & {y}_{n 2} & … & {y}_{nb}\end{matrix} ] \qquad ( Equation 3 )$$

In this case, YM may denote an output matrix YM and y₁₁ to y_{nb} may respectively represent different output elements. For example, y₁₁ to y_{1b} may represent output elements included in the first output element row of the output matrix YM, and yₙ₁ to y_{nb} may represent output elements included in the n-th output element row.

In an embodiment, “n” and “m” may be the same integer. For example, the weight matrix WM may be implemented as a square matrix. In this case, the input matrix XM and the output matrix YM may have the same dimension. However, the scope of the disclosure is not limited thereto, and as such, according to another embodiment, “n” and “m” may be different.

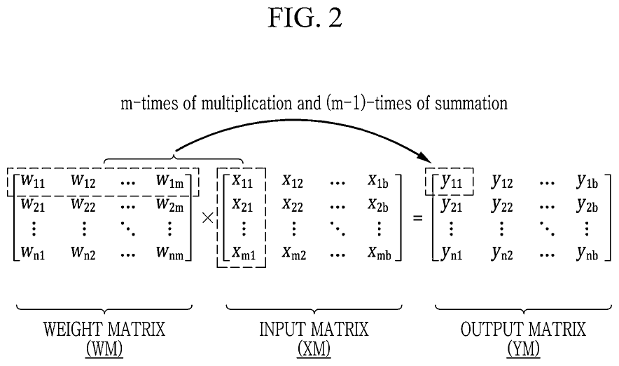

In an embodiment, in an example case in which the matrix multiplication system MMS calculates the output matrix YM by directly multiplying the weight matrix WM and the input matrix XM, the matrix multiplication system MMS may have to process a very large computation amount. In this case, the operation speed of the matrix multiplication system MMS may be deteriorated. The operation of the matrix multiplication system MMS, which obtains the output matrix YM by directly multiplying the weight matrix WM and the input matrix XM, will be described in more detail with reference to FIG. 2.

In another example case in which matrix multiplication system MMS calculates the output matrix YM by multiplying the input matrix XM to the weight matrix WM approximated based on the plurality of pruned small sub-matrices PSM_S and the plurality of pruned large sub-matrices PSM_L, the computation amount of the matrix multiplication system MMS may be greatly reduced compared to a case of obtaining the output matrix YM by directly multiplying the input matrix XM to the weight matrix WM. For example, since a plurality of zero elements may be included in each of the plurality of pruned small sub-matrices PSM_S and the plurality of pruned large sub-matrices PSM_L, the computation amount of the matrix multiplication system MMS may be greatly reduced accordingly. The operation of the matrix multiplication system MMS that calculates the output matrix YM based on the plurality of pruned small sub-matrices PSM_S and the plurality of pruned large sub-matrices PSM_L will be described in more detail with reference to the following drawings.

FIG. 2 illustrates the operation of the matrix multiplication system implemented to directly multiply the weight matrix and the input matrix of FIG. 1. Referring to FIG. 1 and FIG. 2, the matrix multiplication system MMS may obtain the output matrix YM by directly multiplying the weight matrix WM and the input matrix XM.

For example, in order to obtain one output element included in the output matrix YM, the matrix multiplication system MMS may perform m-times of multiplication operations and then perform (m−1)-times of summation operations. For example, the matrix multiplication system MMS may calculate one of the output elements (e.g., y₁₁) included in the output matrix YM in a manner similar to Equation 4 below.

$${y}_{11} = {w}_{11} \times {x}_{11} + {w}_{12} \times {x}_{21} + … + {w}_{1 m} \times {x}_{m 1} \qquad ( Equation 4 )$$

In this manner, the matrix multiplication system MMS may need to perform (n×b×m)-times of multiplication operations and (n×b×(m−1))-times of summation operations to obtain the output matrix YM. Accordingly, due to the excessive calculation amount processed by the matrix multiplication system MMS, the operation speed of the AI model driven based on the matrix multiplication system MMS may be deteriorated.

FIGS. 3, 4, and 5 illustrate the operation of the matrix pruning device of FIG. 1. Referring to FIG. 1 to FIG. 3, the matrix pruning device 100 may generate a plurality of pruning groups PG based on the weight matrix WM. For example, the matrix pruning device 100 may split the weight matrix WM into a plurality of pruning groups PG. For example, the matrix pruning device 100 may generate one pruning group PG for each two adjacent rows of the weight matrix WM. In this case, the first weight row and the second weight row of the weight matrix WM may form a first pruning group PG1, the third weight row and the fourth weight row may form a second pruning group PG2, the fifth weight row and the sixth weight row may form a third pruning group PG3, and the seventh weight row and the eighth weight row may form a fourth pruning group PG4. However, the scope of the disclosure is not limited thereto, and the matrix pruning device 100 may split the weight matrix WM into a plurality of pruning groups PG in any manner. For example, the matrix pruning device 100 may split the weight matrix WM so that each of the plurality of pruning groups PG includes a plurality of weight rows spaced apart from each other. For example, the first weight row and the third weight row of the weight matrix WM may form a first pruning group and the second weight row and the fourth weight row of the weight matrix WM may form a second pruning group. In another embodiment, more than two rows may form a pruning group.

For a more concise explanation, in FIG. 3, an embodiment in which the matrix pruning device 100 splits the weight matrix WM so that each of the plurality of pruning groups PG includes two adjacent weight rows is representatively described, but the scope of the disclosure is not limited thereto, and as such, according to another embodiment, more than two rows may form a pruning group. For example, the matrix pruning device 100 may split the weight matrix WM such that each of the plurality of pruning groups PG includes 2ⁱ (where i is an integer greater than 0) adjacent weight rows.

In an embodiment, each of the plurality of pruning groups PG may include the same number of weight rows. However, the scope of the disclosure is not limited thereto.

In an embodiment, each of the plurality of pruning groups PG may include different weight rows. That is, each of the plurality of pruning groups PG may include weight rows exclusively. For example, a weight row included in the first pruning group PG1 may not be included in other pruning groups. However, the scope of the disclosure is not limited thereto, and as such, according to another embodiment, a weight row included in the first pruning group PG1 may be included in another pruning group.

The matrix pruning device 100 may calculate group importance of each of the plurality of pruning groups PG. For example, the matrix pruning device 100 may calculate group importance of each of the first to fourth pruning groups PG1 to PG4.

In an embodiment, group importance of each of the plurality of pruning groups PG may be determined based on weights included in the pruning group PG. For example, group importance of each of the plurality of pruning groups PG may be determined based on the sum of weights included in the pruning group PG, determined based on the sum of the absolute values of weights included in the pruning group PG, or determined based on the sum of squares of weights included in the pruning group PG. However, the scope of disclosure is not limited thereto, and the group importance of each of the plurality of pruning groups PG may be any type of function value calculated based on weights included in the pruning group PG.

In an embodiment, the group importance of each of the plurality of pruning groups PG may be determined based on the deviation of the weights included in each pruning group PG. For example, a pruning group PG containing a relatively large number of outlier weights may have relatively high group importance. For example, a first group with a larger number of outlier weights than a second group may be determined as have a higher group importance. However, the scope of the disclosure is not limited thereto

The matrix pruning device 100 may classify the plurality of pruning groups PG into an important pruning group IPG and an unimportant pruning group UIPG based on group importance. For example, the matrix pruning device 100 may classify a pruning group PG with group importance higher than a group importance threshold (hereinafter referred to as GIPTH) into the important pruning group IPG, and a pruning group PG with group importance lower than the group importance threshold value GIPTH into the unimportant pruning group UIPG.

For a more detailed example, in a case in which the group importance of the first and fourth pruning groups PG1 and PG4 is higher than the group importance threshold value GIPTH, the matrix pruning device 100 may classify the first pruning group PG1 and the fourth pruning group PG4 as the important pruning group IPG. In another example case in which the group importance of the second pruning group PG2 and third pruning group PG3 is lower than the group importance threshold value GIPTH, the matrix pruning device 100 may classify the second and third pruning groups PG2 and PG3 as the unimportant pruning group UIPG.

The matrix pruning device 100 may generate the plurality of small sub-matrices SM_S based on the plurality of important pruning groups IPG. For example, the matrix pruning device 100 may generate one small sub-matrix SM_S based on one important pruning group IPG.

The matrix pruning device 100 may generate a plurality of large sub-matrices SM_L based on the plurality of unimportant pruning groups UIPG. For example, the matrix pruning device 100 may generate one large sub-matrix SM_L based on two or more unimportant pruning groups UIPG.

For example, the large sub-matrix SM_L may be generated based on a larger number of pruning groups PG than the small sub-matrix SM_S. For example, the matrix pruning device 100 may merge a plurality of unimportant pruning groups UIPG to generate one large sub-matrix SM_L, and may convert one important pruning group IPG to one small sub-matrix SM_S. For example, the matrix pruning device 100 may convert one or more important pruning group IPG to one or more small sub-matrix SM_S, respectively.

In other words, the number of pruning groups PG included in one large sub-matrix SM_L may be greater than the number of pruning groups PG included in one small sub-matrix SM_S. In this case, the number of weight rows included in one large sub-matrix SM_L may be greater than the number of weight rows included in one small sub-matrix SM_S.

In an embodiment, the number of pruning groups PG included in one large sub-matrix SM_L may be an integer times of the number of pruning groups PG included in one small sub-matrix SM_S.

In an embodiment, the number of pruning groups PG included in one large sub-matrix SM_L may be 2ⁱ times of the number of pruning groups PG included in one small sub-matrix SM_S (where i is any integer of 1 or more).

Hereinafter, for a more concise description, an embodiment in which the matrix pruning device 100 transforms one important pruning group IPG into one small sub-matrix SM_S and merges two unimportant pruning groups UIPG to generate one large sub-matrix SM_L will be representatively described. However, the scope of the disclosure is not limited thereto. For example, the matrix pruning device 100 may be implemented to merge the plurality of important pruning groups IPG to generate one small sub-matrix SM_S, or to merge three or more unimportant pruning groups UIPG to generate one large sub-matrix SM_L.

The matrix pruning device 100 may transform the first pruning group PG1 into a first small sub-matrix SM_S1 and the fourth pruning group PG4 into a second small sub-matrix SM_S2. The matrix pruning device 100 may generate a first large sub-matrix SM_L1 by merging the second and third pruning groups PG2 and PG3. In such manner, the matrix pruning device 100 may generate a plurality of small sub-matrices SM_S and a plurality of large sub-matrices SM_L based on the plurality of pruning groups PG.

For example, the matrix pruning device 100 may split the weight matrix WM into a plurality of small sub-matrices SM_S and a plurality of large sub-matrices SM_L. In this case, the number of rows (i.e., “n”) of the weight matrix WM may be equal to the total number of rows of plurality of small sub-matrices SM_S and the number of rows of plurality of large sub-matrices SM_L.

In an embodiment, the matrix pruning device 100 may generate one large sub-matrix SM_L by merging adjacent unimportant pruning groups UIPG. However, the disclosure is not limited thereto, and the matrix pruning device 100 may generate one large sub-matrix SM_L by merging separated unimportant pruning groups UIPG.

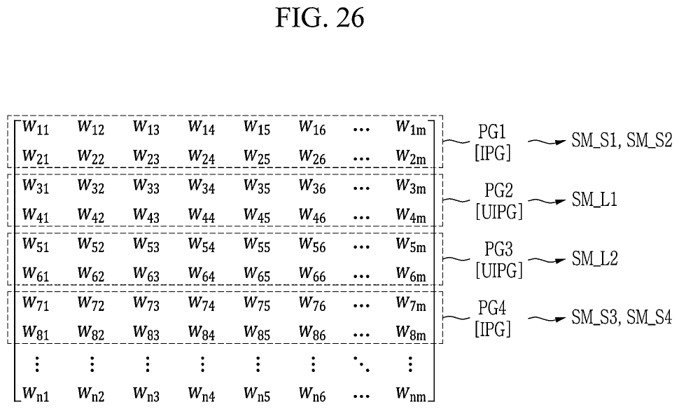

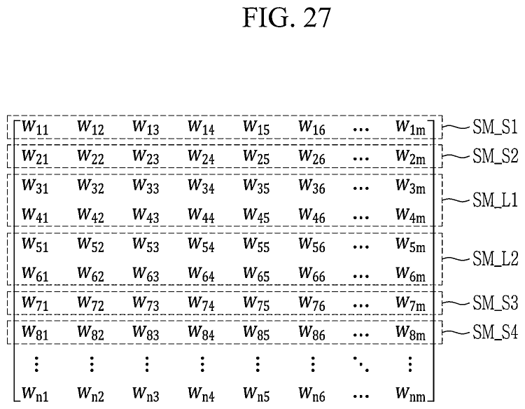

In an embodiment, the matrix pruning device 100 may be implemented to generate the plurality of small sub-matrices SM_S by splitting the important pruning group IPG and transforming one important pruning group IPG to one large sub-matrix SM_L. An embodiment in which the matrix pruning device 100 generates a plurality of small sub-matrices by splitting the important pruning group IPG will be described in more detail with reference to FIG. 26 to FIG. 27.

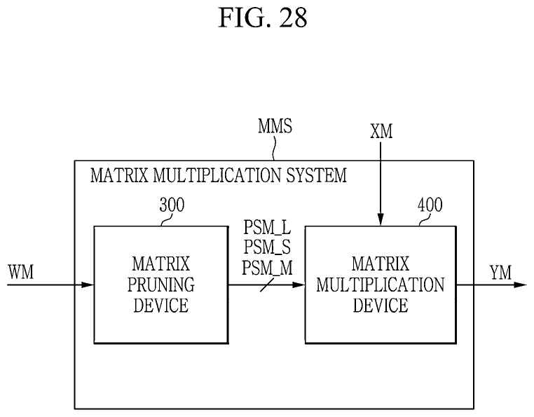

In an embodiment, the matrix pruning device 100 may further generate a plurality of medium sub-matrices SM_M based on group importance of each of the plurality of pruning groups PG. In this case, the size of the small sub-matrix SM_S, the medium sub-matrix SM_M, and the large sub-matrix SM_L may be different. For example, the number weight rows of the small sub-matrix SM_S, the medium sub-matrix SM_M, and the large sub-matrix SM_L may be different. A method by which the matrix pruning device 100 classifies the weight matrix WM into three or more sub-matrix types with different sizes will described in more detail with reference to FIG. 28 to FIG. 30.

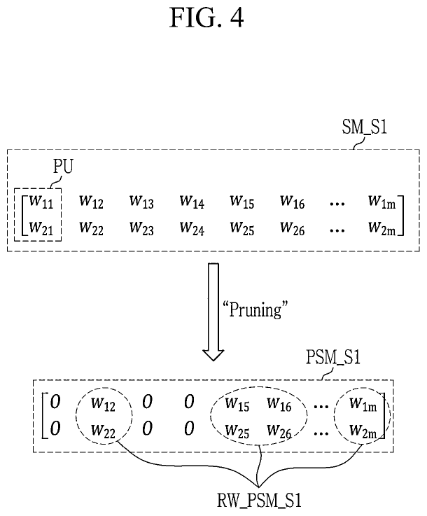

Referring to FIG. 1 to FIG. 4, the matrix pruning device 100 may generate a plurality of pruned small sub-matrices PSM_S by pruning the plurality of small sub-matrices SM_S, respectively. For example, the matrix pruning device 100 may generate a first pruned small sub-matrix PSM_S1 by pruning a first small sub-matrix SM_S1. Hereinafter, for a more concise description, In FIG. 4, the operation of the matrix pruning device 100, which prunes the first small sub-matrix SM_S1, is representatively described, but the scope of the disclosure is not limited thereto. For example, the matrix pruning device 100 may also prune a second small sub-matrix SM_S2 in a similar manner.

The matrix pruning device 100 may prune the first small sub-matrix SM_S1 with column units. For example, w₁₁ and w₂₁ may form one pruning unit PU, and w₁₂ and w₂₂ may form another pruning unit PU. However, the scope of disclosure is not limited thereto, and each of the plurality of columns included in the first small sub-matrix SM_S1 may form a different pruning unit PU.

The matrix pruning device 100 may calculate column importance of each of the plurality of pruning units PU.

In an embodiment, column importance of each of the plurality of pruning units PU may be determined based on values of weights included in the pruning unit PU. For example, the column importance of each the plurality of pruning units PU may be determined based on sum of values of weights included in the pruning unit PU, may be determined based on sum of absolute values of weights included in the pruning unit PU, or may be determined based on the sum of squares of values of weights included in the pruning unit PU. However, the scope of disclosure is not limited thereto, and the column importance of each of the plurality of pruning units PU may be any type of function value that calculated based on weights included in the pruning unit PU.

In an embodiment, the column importance for the pruning unit PU and the group importance for the pruning group PG may be calculated based on the same functions. However, the disclosure is not limited thereto, and as such, the column importance for the pruning unit PU and the group importance for the pruning group PG may be calculated based on one or more different functions.

The matrix pruning device 100 may prune each of the plurality of pruning units PU based on the column importance of each of the plurality of pruning units PU. For example, the matrix pruning device 100 may maintain top four pruning units with relatively high column importance among the plurality of pruning units PU included in the first small sub-matrix SM_S1, and change weights included in the remaining pruning unit to zero element (i.e., “0”). For example, the matrix pruning device 100 may obtain four pruning units with four highest column importance among the plurality of pruning units PU included in the first small sub-matrix SM_S1. For a more detailed example, the matrix pruning device 100 may maintain weights included in second, fifth, sixth, and m-th columns corresponding to the pruning unit PU with relatively high column importance, and may change weights included in the other columns to the zero element. In this way, the matrix pruning device 100 may determine elements of the first pruned small sub-matrix PSM_S1.

Hereinafter, for a more concise explanation, the weights (e.g., non-zero elements) included in the pruned small sub-matrix PSM_S will be referred to as residual weights RW. For example, residual weights RW included in the first pruned small sub-matrix PSM_S1 may be referred to as residual weights RW_PSM_S1.

In an embodiment, the number of columns including the residual weights of the pruned small sub-matrix PSM_S may be determined in advance. That is, in an example case in which pruning the sub-matrix SM_S, the number of pruning units that will maintain weights may be determined in advance. For example, the matrix pruning device 100 may be configured to maintain a predetermined number of pruning units with relatively high column importance among the plurality of pruning units PU included in the first small sub-matrix SM_S1.

For a more concise explanation, hereinafter, an embodiment in which the matrix pruning device 100 maintains four pruning units with the highest column importance among the plurality of small sub-matrices PSM_S, and transforms the remaining pruning units into zero elements, by performing the pruning operation will be representatively described. However, the scope of the disclosure is not limited thereto. For example, the number of top pruning units obtained by the matrix pruning device 100 may be different than four. According to another embodiment, the matrix pruning device 100 performs the pruning operation by maintaining weights included in the pruning units with higher column importance than a column importance threshold value, and changing weights included in the pruning unit PU with lower column importance than the column importance threshold value to zero elements.

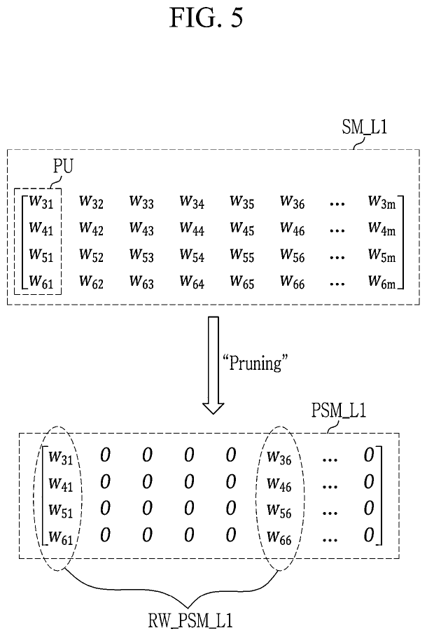

Similarly, referring to FIG. 1 to FIG. 5, the matrix pruning device 100 may generate a plurality of pruned large sub-matrices PSM_L by pruning each of the plurality of large sub-matrices SM_L. For example, the matrix pruning device 100 may generate a first pruned large sub-matrix PSM_L1 by pruning a first large sub-matrix SM_L1. Below, for a more concise explanation, the operation of matrix pruning device 100, which prunes the first large sub-matrix SM_L1, will be representatively described in FIG. 5, but the scope of the disclosure is not limited thereto. For example, the matrix pruning device 100 may prune each of the plurality of large sub-matrices SM_L previously described with reference to FIG. 3 in a similar manner.

The matrix pruning device 100 may prune the first large sub-matrix SM_L1 with column units. For example, w₃₁ to w₆₁ may form one pruning unit PU, and w₃₂ to w₆₂ may form another pruning unit PU. However, the scope of the disclosure is not limited thereto, and each of the plurality of columns included in the first large sub-matrix SM_L1 may for a different pruning unit PU.

The matrix pruning device 100 may prune each of the plurality of pruning units PU based on the column importance of each of the plurality of pruning units PU. For example, the matrix pruning device 100 may change weights included in the second to fifth and the m-th columns of the first large sub-matrix SM_L1 to zero elements. In another example, the matrix pruning device 100 may not change weights included in the first and sixth columns of the first large sub-matrix SM_L1. The method in which the matrix pruning device 100 prunes each of the plurality of pruning units PU included in the first large sub-matrix SM_L1 is similar to the method previously described with reference to FIG. 4, and therefore no detailed description will be provided.

According to an embodiment of the disclosure, the matrix pruning device 100 may prune the small sub-matrix SM_S and the large sub-matrix SM_L based on pruning units with different size. According to an embodiment, the matrix pruning device 100 may prune the small sub-matrix SM_S based on a pruning unit of a smaller size than the pruning unit of the large sub-matrix SM_L. In this case, an important pruning group IPG included in the small sub-matrix SM_S can be pruned relatively finely, and therefore, errors due to pruning of the weight matrix WM (e.g., operation errors of an artificial intelligence model including the matrix multiplication system MMS) can be minimized.

Hereinafter, for a more concise description, weights included in the pruned large sub-matrix PSM_L (e.g., non-zero elements) may be referred to as residual weights RW. For example, residual weights RW included in the first pruned large sub-matrix PSM_L1 may be referred to as residual weights RW_PSM_L1.

In an embodiment, the matrix pruning device 100 may prune the plurality of small sub-matrices SM_S so that the number of columns including the residual weights of each of the plurality of pruned small sub-matrices PSM_S to be same. In other words, the matrix pruning device 100 may prune the plurality of small sub-matrices SM_S with identical pruning ratio.

In an embodiment, the matrix pruning device 100 may prune the plurality of pruned large sub-matrices PSM_L so that the number of columns including the residual weights of each of the plurality of large sub-matrices SM_L to be same. That is, the matrix pruning device 100 may prune the plurality of large sub-matrices SM_L with identical pruning ratio.

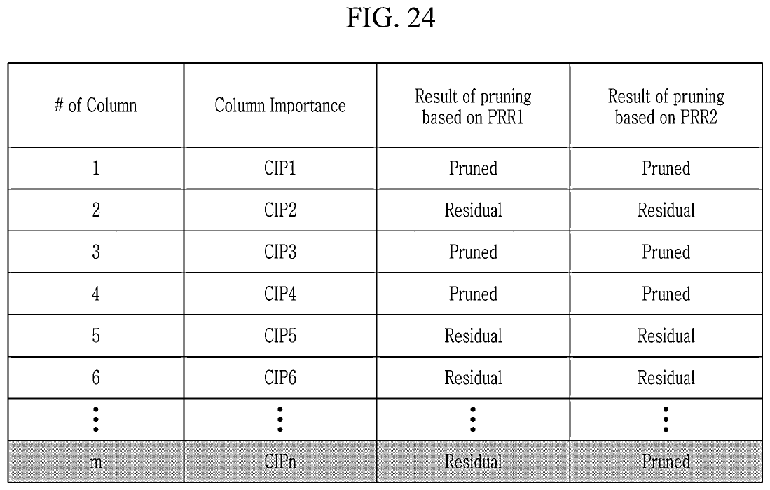

In an embodiment, the number of columns including residual weights of the plurality of pruned small sub-matrices PSM_S and the number of columns including residual weights of the plurality of pruned large sub-matrices PSM_L may be the same. In another embodiment, the number of columns including residual weights of the plurality of pruned small sub-matrices PSM_S and the number of columns including residual weights of the plurality of pruned large sub-matrices PSM_L may be different. For example, the matrix pruning device 100 may adjust the pruning ratio of the plurality of small sub-matrices SM_S and the plurality of large sub-matrices SM_L to be same or different from each other. An embodiment in which the matrix pruning device 100 adjusts the pruning ratio of the plurality of small sub-matrices SM_S and the plurality of large sub-matrices SM_L will be described in more detail with reference to FIG. 24.

Hereinafter, for a more concise explanation, a column number of column which including the residual weights of the pruned small sub-matrices PSM_S and the pruned large sub-matrices PSM_L is referred to as residual weight index RWI. For example, a residual weight index RWI for the pruned small sub-matrices PSM_S is referred to as “RWI_PSM_S”, and a residual weight index RWI for the pruned large sub-matrices PSM_L is referred to as “RWI_PSM_L”. For a more detailed example, a residual weight index RWI for the first pruned small sub-matrix PSM_S1 is referred to as RWI_PSM_S1, and a residual weight index RWI for the first pruned large sub-matrix PSM_L1 is referred to as RWI_PSM_L1. However, the scope of the disclosure is not limited thereto.

FIG. 6 is a block diagram illustrating a matrix multiplication device of FIG. 1 in detail. Referring to FIG. 1 to FIG. 6, a matrix multiplication device 200 may include a weight memory circuit 210, a control logic circuit 220, an input matrix buffer 230, a first processing element array 240_S, a second processing element array 240_L, and an output merging circuit 250.

Hereinafter, for a more concise description, an embodiment in which the first processing element array 240_S performs a matrix multiplication operation for an input matrix XM of each of the plurality of pruned small sub-matrices PSM_S, and the second processing element array 240_L performs a matrix multiplication operation for an input matrix XM of each of the plurality of pruned large sub-matrices PSM_L will be representatively described. However, the scope of the disclosure is not limited thereto, and as such, according another embodiment, the matrix multiplication device 200 may include a first plurality of processing element arrays performing a matrix multiplication operation for an input matrix XM of each of the plurality of pruned small sub-matrices PSM_S separately, and a second plurality of processing element arrays performing a matrix multiplication operation for an input matrix XM of each of the plurality of pruned large sub-matrices PSM_L separately. Also, according to still another embodiment, the matrix multiplication device 200 may include only single processing element array performing matrix multiplication operations for an input matrix XM of both of the plurality of pruned small sub-matrices PSM_S and the plurality of pruned large sub-matrices PSM_L.

The weight memory circuit 210 may receive the plurality of pruned large sub-matrices PSM_L and the plurality of pruned small sub-matrices PSM_S. That is, the weight memory circuit 210 may receive weight matrices WM approximated in a plurality of pruned sub-matrix format having different sizes.

In an embodiment, the number of columns for each of plurality of pruned large sub-matrices PSM_L and plurality of pruned small sub-matrices PSM_S may be the same.

In an embodiment, the number of rows of the plurality of pruned large sub-matrices PSM_L may be an integer multiple of the number of rows of the plurality of pruned small sub-matrices PSM_S.

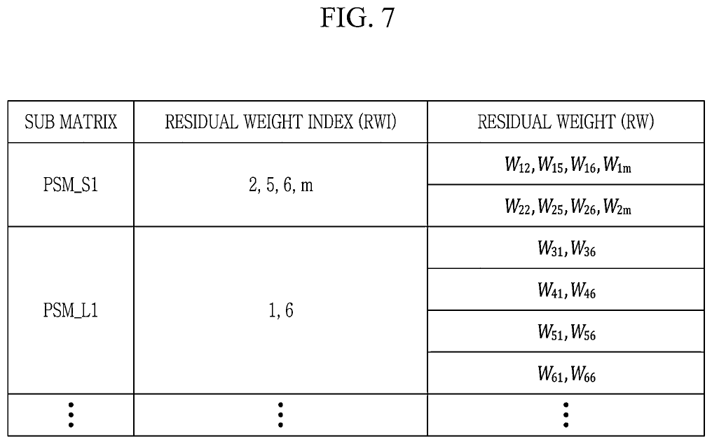

The weight memory circuit 210 may store the plurality of pruned large sub-matrices PSM_L and the plurality of pruned small sub-matrices PSM_S in form of residual weights RW and residual weight indexes RWI, respectively. For example, the weight memory circuit 210 may store residual weights RW and a column number in which residual weights RW being arranged. In this case, the weight memory circuit 210 may not store all elements (e.g., zero elements and residual weights) included in the plurality of pruned large sub-matrices PSM_L and the plurality of pruned small sub-matrices PSM_S. However, the disclosure is not limited thereto, and as such, according to another embodiment, the weight memory circuit 210 or another memory circuit may store some or all elements (e.g., zero elements and residual weights) included in the plurality of pruned large sub-matrices PSM_L and the plurality of pruned small sub-matrices PSM_S. The method in which the weight memory circuit 210 stores the plurality of pruned large sub-matrices PSM_L and the plurality of pruned small sub-matrices PSM_S will be described in more detail hereinafter with reference to FIG. 7.

In an embodiment, the weight memory circuit 210 may be a dynamic random access memory (DRAM). However, the scope of the disclosure is not limited thereto, and the weight memory circuit 210 may be any type of memory circuit.

The control logic circuit 220 may receive residual weight indexes RWI of each of the plurality of pruned large sub-matrices PSM_L and the plurality of pruned small sub-matrices PSM_S from the weight memory circuit 210. The control logic circuit 220 may control the operation of the input matrix buffer 230 based on the residual weight indexes RWI.

The input matrix buffer 230 may receive an input matrix XM. For example, the input matrix buffer 230 may receive a plurality of input elements included in the input matrix XM.

The control logic circuit 220 may control the input matrix buffer 230 to output input elements to be multiplied by the plurality of pruned small sub-matrices PSM_S, based on the residual weight indexes RWI for the plurality of pruned small sub-matrices PSM_S. Similarly, the control logic circuit 220 may control the input matrix buffer 230 to output input elements to be multiplied by the plurality of pruned large sub-matrices PSM_L, based on the residual weight indexes RWI for the plurality of pruned large sub-matrices PSM_L.

The input matrix buffer 230 may output input elements corresponding to the residual weight indexes RWI, based on the control of the control logic circuit 220. For example, the input matrix buffer 230 may provide input elements to be multiplied with the plurality of pruned small sub-matrices PSM_S to a first processing element array 240_S, based on a residual weight indexes RWI_PSM_S provided from the control logic circuit 220. Similarly, the input matrix buffer 230 may provide input elements to be multiplied with the plurality of pruned large sub-matrices PSM_L to a second processing element array 240_L, based on a residual weight index RWI_PSM_L provided from the control logic circuit 220.

For a more detailed example, in a case in which the first processing element array 240_S obtains the product of the first pruned small sub-matrix PSM_S1 and the input matrix XM, the control logic circuit 220 may provide the residual weight index RWI (e.g., 2, 5, 6, m) to the input matrix buffer 230. In this case, the input matrix buffer 230 may provide input elements included in second, fifth, sixth, and m-th input element rows of the input matrix XM to the first processing element array 240_S. In this way, according to the residual weight index RWI provided from the control logic circuit 220, the input matrix buffer 230 may provide input elements corresponding to each of the plurality of pruned small sub-matrices PSM_S to the first processing element array 240_S, and may provide input elements respectively corresponding to each of the plurality of the pruned large sub-matrices PSM_L to the second processing element array 240_L.

The first processing element array 240_S may receive residual weights RW_PSM_S included in the plurality of pruned small sub-matrices PSM_S from the weight memory circuit 210. For example, the first processing element array 240_S may receive residual weights RW_PSM_S1 included in the first pruned small sub-matrix PSM_S1, and may receive residual weights RW_PSM_S2 included in the second pruned small sub-matrix PSM_S2.

The second processing element array 240_L may receive residual weights RW_PSM_L included in the plurality of pruned large sub-matrices PSM_L from the weight memory circuit 210. Since the method in which the second processing element array 240_L receives residual weights is similar to the method in which the first processing element array 240_S receives residual weights, no further detailed description will be provided.

Each of the first processing element array 240_S and the second processing element array 240_L may generate sub-output matrices of different sizes each other, based on the received residual weights RW and input elements IE. For example, the first processing element array 240_S may generate a plurality of small sub-output matrices SYM_S corresponding to the product of the input matrix XM and each of the plurality of pruned small sub-matrices PSM_S, and the second processing element array 240_L may generate a plurality of pruned large sub-output matrices SYM_L corresponding to the product of input matrix XM and each of the plurality of pruned large sub-matrices PSM_L.

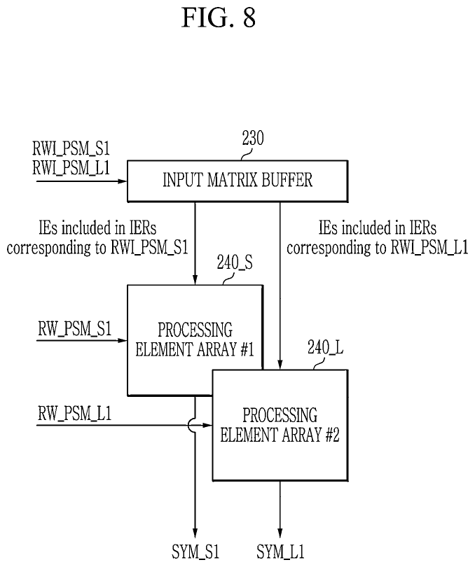

For example, the first processing element array 240_S may calculate a plurality of output elements, based on the residual weight values RW_PSM_S included in the plurality of pruned small sub-matrices PSM_S and input elements IE corresponding to the plurality of pruned small sub-matrices PSM_S. Similarly, the second processing element array 240_L may obtain a plurality of output elements, based on the residual weight values RW_PSM_L included in the plurality of pruned large sub-matrices PSM_L and input elements IE corresponding to the plurality of pruned large sub-matrices PSM_L. The configuration and operation of the first processing element array 240_S and the second processing element array 240_L will be described in more detail with reference to FIGS. 8, 9, 10, 11 and 12.

In an embodiment, the number of rows of plurality of pruned small sub-matrices PSM_S may be the same as the number of rows of plurality of small sub-output matrix SYM_S. Similarly, the number of rows of plurality of pruned large sub-matrices PSM_L may be the same as the number of rows of plurality of large sub-output matrices SYM_L.

In an embodiment, the number of columns of each of the plurality of small sub-output matrices SYM_S and each of the plurality of large sub-output matrices SYM_L may be the same as the number of columns of the output matrix YM.

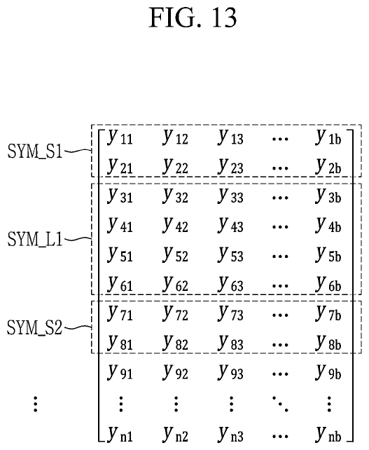

The output merging circuit 250 may receive the plurality of small sub-output matrices SYM_S and the plurality of large sub-output matrices SYM_L. The output merging circuit 250 may generate the output matrix YM by merging the plurality of small sub-output matrices SYM_S and the plurality of large sub-output matrices SYM_L. The operation of the output merging circuit 250 will be described in more detail with reference to FIG. 13.

The control logic circuit 220 may control overall operations of the matrix multiplication device 200. For example, the control logic circuit 220 may provide a command or a control signal to control operation timing of each of the weight memory circuit 210, the control logic circuit 220, the input matrix buffer 230, the first processing element array 240_S, the second processing element array 240_L, and the output merging circuit 250.

FIG. 7 is a table illustrating residual weight indexes and residual weights stored in the weight memory circuit of FIG. 6. Referring to FIG. 1 to FIG. 7, the weight memory circuit 210 may store the residual weights RW and the residual weight indexes RWI for each of the plurality of pruned large sub-matrices PSM_L and plurality of pruned small sub-matrices PSM_S. Hereinafter, for a more concise description, in FIG. 7, the residual weights RW and the residual weight index RWI for the first pruned small sub-matrix PSM_S1 and the first pruned large sub-matrix PSM_L1 are illustrated, but the scope of the disclosure is not limited thereto. For example, the weight memory circuit 210 may store a residual weight RW and a residual weight index RWI for each of the plurality of pruned large sub-matrices PSM_L and the plurality of pruned small sub-matrices PSM_S in a similar way of the residual weights RW and the residual weight index RWI stored for the first pruned small sub-matrix PSM_S1 and the first pruned large sub-matrix PSM_L1.

The weight memory circuit 210 may store residual weight indexes 2, 5, 6, and m for the first pruned small sub-matrix PSM_S1. That is, the weight memory circuit 210 may store numbers of columns including the residual weight in the first pruned small sub-matrix PSM_S1 as the residual weight indexes RWI.

In an embodiment, the weight memory circuit 210 may store residual weights RW of the first pruned small sub-matrix PSM_S1 for each row. For example, the weight memory circuit 210 may store the residual weights w₁₂, w₁₅, w₁₆, and w₁ₘ included in the first row of the first pruned small sub-matrix PSM_S1 in consecutive addresses (e.g., store w₁₂, w₁₅, w₁₆, and w₁ₘ sequentially), and may store the residual weights w₂₂, w₂₅, w₂₆, w₂ₘ included in the second row of the first pruned small sub-matrix PSM_S1 in consecutive addresses.

In an example case in which a plurality of residual weights RW included in one row of the pruned small sub-matrix PSM_S are stored in consecutive addresses, the plurality of residual weights RW required to calculate each output element may be continuously read out from the weight memory circuit 210. In this case, time required to provide the plurality of residual weights RW stored in the weight memory circuit 210 to the processing element array can be minimized, and thus the operation speed of the matrix multiplication device 200 can be improved. However, the scope of the disclosure is not limited thereto. For example, the weight memory circuit 210 may split and store the plurality of residual weights RW included in single row of the first pruned small sub-matrix PSM_S1 to non-consecutive addresses (e.g., store them in an interleaving manner).

The weight memory circuit 210 may store residual weight index RWI “1” and “6” for the first pruned large sub-matrix PSM_L1. That is, the weight memory circuit 210 may store the residual weight indexes RWI as column number of which including the residual weight in the first pruned large sub-matrix PSM_L1.

In an embodiment, the weight memory circuit 210 may store residual weights RW of the first pruned large sub-matrix PSM_L1 for each row. For example, the weight memory circuit 210 may store the residual weights RW of the first pruned large sub-matrix PSM_L1, similar to the method of storing the residual weights RW of the first pruned small sub-matrix PSM_S1.

FIG. 8 to FIG. 12 are block diagrams illustrating the operation of some configuration of FIG. 6 in detail. Hereinafter, for a more concise description, a method for the matrix multiplication device 200 to generate a first small sub-output matrix SYM_S1 corresponding to the multiplication of the first pruned small sub-matrix PSM_S1 and the input matrix XM, and to generate a first large sub-output matrix SYM_L1 corresponding to the multiplication of the first pruned large sub-matrix PSM_L1 and the input matrix XM will be representatively described. However, the scope of the disclosure is not limited thereof, and similar to the above-stated method, the matrix multiplication device 200 may generate a plurality of small sub-output matrix SYM_S corresponding to the multiplication of each of the plurality of pruned small sub-matrices PSM_S and the input matrix XM, and may generate a plurality of large sub-output matrices SYM_L corresponding to the multiplication of each of the plurality of pruned large sub-matrices PSM_L and the input matrix XM.

Referring to FIG. 1 to FIG. 8, the input matrix buffer 230 may receive a residual weight index RWI_PSM_S1 for the first pruned small sub-matrix PSM_S1. The input matrix buffer 230 may provide input elements included in input element rows IER corresponding to the residual weight index RWI_PSM_S1 to the first processing element array 240_S.

For example, the input matrix buffer 230 may output input elements included in second, fifth, sixth, and m-th rows of the input matrix XM to the first processing element array 240_S. For a more detailed example, referring to FIGS. 4 and 8, the input matrix buffer 230 may output x₂₁ to x_{2b} (e.g., input elements included in the second input element row), x₅₁ to x_{5b} (e.g., input elements included in the fifth input element row), x₆₁ to x_{6b} (e.g., input elements included in the sixth input element row), and xₘ₁ to x_{mb} (e.g., input elements included in the m-th input element row) to the first processing element array 240_S.

Similarly, the input matrix buffer 230 may receive a residual weight indexes RWI_PSM_L1 for the first pruned large sub-matrix PSM_L1. The input matrix buffer 230 may provide input elements included in input element rows IER corresponding to the residual weight indexes RWI_PSM_L1 to the second processing element array 240_L.

In other words, the input matrix buffer 230 may output input elements included in the first and sixth rows of the input matrix XM to the second processing element array 240_L. For a more detailed example, referring to FIGS. 5 and 8, the input matrix buffer 230 may output x₁₁ to x_{1b} (e.g., input elements included in the first input element) and x₆₁ to x_{6b} (e.g., input elements included in the sixth input element) to the second processing element array 240_L.

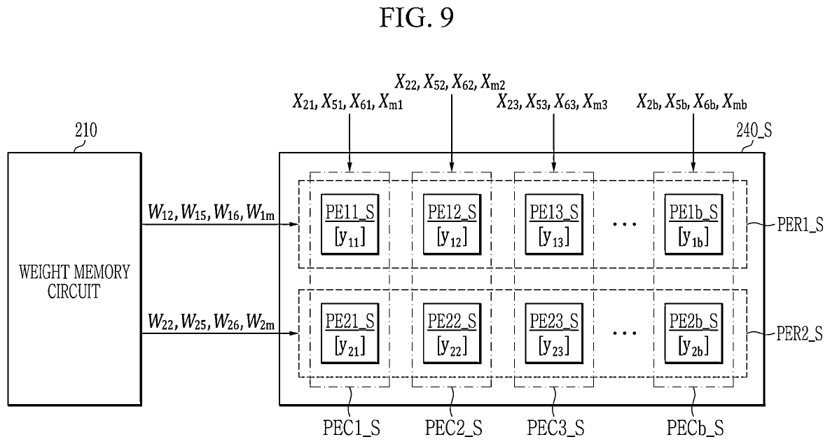

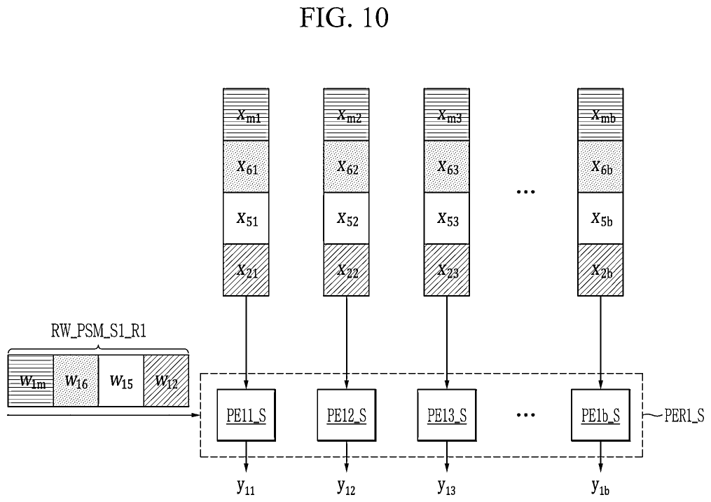

The first processing element array 240_S may receive residual weights RW_PSM_S1 for the first pruned small sub-matrix PSM_S1. The first processing element array 240_S may generate a first small sub-output matrix SYM_S1 based on input elements corresponding to residual weights RW_PSM_S1 and a residual weight indexes RWI_PSM_S1. A method for the first processing element array 240_S to generate the first small sub-output matrix SYM_S1 will be described in more detail with reference to FIG. 9 to FIG. 10.

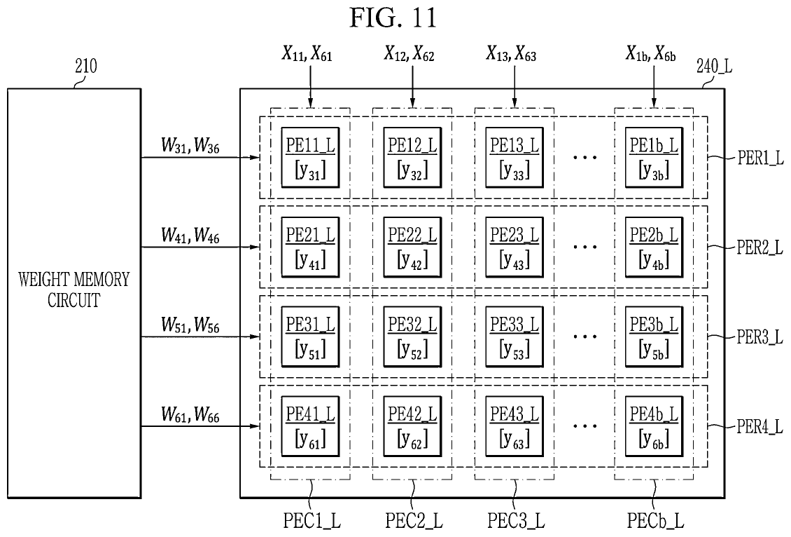

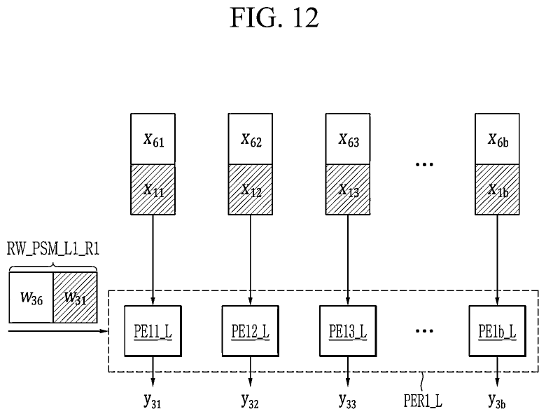

Similarly, the second processing element array 240_L may receive a residual weight RW_PSM_L1 for the first pruned large sub-matrix PSM_L1. The second processing element array 240_L may generate a first large sub-output matrix SYM_L1 based on input elements corresponding to residual weights RW_PSM_L1 and residual weight indexes RWI_PSM_L1. A method for the second processing element array 240_L to generate the first large sub-output matrix SYM_L1 will be described in more detail with reference to FIG. 11 to FIG. 12.

In an embodiment, the first processing element array 240_S may be greater than the second processing element array 240_L in size. For example, the first processing element array 240_S may include more processing elements than the second processing element array 240_L. The configuration of the first processing element array 240_S and the second processing element array 240_L will be described in more detail with reference to FIG. 9 to FIG. 12.

In an embodiment, the first processing element array 240_S and the second processing element array 240_L may be different parts of one processing element array. For example, the first processing element array 240_S and the second processing element array 240_L may be different regions, which are included within one processing element array and have different size each other, allocated to perform matrix multiplication operations on matrices of different sizes. However, the scope of the disclosure is not limited thereto.

FIG. 9 is a block diagram illustrating the configuration and operation of the first processing element array of FIG. 8 in detail. Referring to FIG. 1 to FIG. 9, the first processing element array 240_S may include a plurality of processing elements PE arranged in the row direction and the column direction.

The plurality of processing elements PE included in the first processing element array 240_S may be arranged in two rows and b columns. That is, the number of rows of the first processing element array 240_S may be the same as the number of rows of each of the plurality of small sub-matrices SM_S, and the number of columns of the first processing element array 240_S may be the same as the number of columns of the input matrix XM.

Hereinafter, for a more concise description, a processing element arranged in an (i)-th row and a (j)-th column of the first processing element array 240_S will be referred to as PEij_S. For example, a processing element arranged in a first row and a second column of the first processing element array 240_S will be referred to as PE12_S.

The first processing element array 240_S may include a first processing element row PER1_S and a second processing element row PER2_S. Each of the first processing element row PER1_S and the second processing element row PER2_S may include a plurality of processing elements PE that are different from each other. For example, the first processing element row PER1_S may include processing elements PE11_S to PE1b_S, and the second processing element row PER2_S may include processing elements PE21_S to PE2b_S.

The first to second processing element rows PER1_S to PER2_S may receive residual weights RW arranged in different rows of the first pruned small sub-matrix PSM_S1. For example, an (i)-th processing element row PERi_S may receive residual weights RW arranged in the (i)-th row of the first pruned small sub-matrix PSM_S1.

In more detail, each of the processing elements included in the first processing element row PER1_S may receive w₁₂, w₁₅, w₁₆, and w₁ₘ, and each of the processing elements included in the second processing element row PER2_S may receive w₂₂, w₂₅, w₂₆, and w₂ₘ.

In an embodiment, a first to b-th processing element column PEC1_S to PECb_S may receive input elements IE arranged in different columns of the input matrix XM. For example, the first processing element column PEC1_S may receive input elements IE arranged in input element rows corresponding to the residual weight indexes RWI_PSM_S1 and the first input element column; and the second processing element column PEC2_S may receive input elements IE arranged in input element rows corresponding to the residual weight indexes RWI_PSM_S1 and the second input element column. In more detail, each processing element included in the first processing element column PEC1_S may receive x₂₁, x₅₁, x₆₁, and xₘ₁, and each processing element included in the second processing element column PEC2_S may receive x₂₂, x₅₂, x₆₂, and xₘ₂. Similarly, the third to b-th processing element columns PEC3_S to PECb_S may receive input elements arranged in different columns of the input matrix XM.

Each of the processing elements PE included in the first processing element array 240_S may output different output elements based on the received plurality of residual weights RW and the received plurality of input elements IE. For example, a processing element PE11_S may output y₁₁, and a processing element PE12_S may output y₁₂. In this way, the first processing element row PER1_S may output y₁₁ to y_{1b}, and the second processing element row PER2_S may output y₂₁ to y_{2b}. For example, each of different processing element rows of the first processing element array 240_S may calculate output elements included in a different row of the output matrix YM, and each of different processing element columns of first processing element array 240_S may calculate output elements included in a different column of the output matrix YM. A specific method in which each processing element PE included in the first processing element array 240_S obtains the output element will be described in more detail with reference to FIG. 10.

FIG. 10 illustrates the operation of the processing element row of FIG. 9 in more detail. That is, hereinafter, the operation of the first processing element row PER1_S will be representatively described with reference to FIG. 1 to FIG. 10. However, the scope of disclosure is not limited thereto, and other processing element rows included in first processing element array 240_S may also operate in a similar manner.

The first processing element row PER1_S may include processing elements PE11_S to PE1b_S. Each of the processing elements PE11_S to PE1b_S may sequentially receive residual weights RW_PSM_S1_R1 included in a first row of the first pruned small sub-matrix PSM_S1. That is, each of the processing elements PE11_S to PE1b_S may sequentially receive w₁₂, w₁₅, w₁₆, and w₁ₘ.

Each of the processing elements PE11_S to PE1b_S may sequentially receive input element IE included in different columns of the input matrix XM. For example, the PE11_S may sequentially receive input element rows corresponding to the residual weight indexes RWI_PSM_S1 and input elements included in the first input element column. That is, the processing element PE11_S may sequentially receive x₂₁, x₅₁, x₆₁, and xₘ₁. Similarly, the processing element PE12_S may sequentially receive x₂₂, x₅₂, x₆₂, and xₘ₂, and the processing element PE1b_S may sequentially receive x_{2b}, x_{5b}, x_{6b}, and x_{mb}. For a more concise explanation, the detailed description of the input elements received by the processing elements in first processing element row PER1_S is omitted.

Each of the processing elements PE11_S to PE1b_S may calculate a different output element based on the order in which the plurality of residual weights RW and the input elements IE are received. For example, the processing elements PE11_S to PE1b_S may calculate y₁₁ to y_{1b}, respectively.

For a more detailed example, the processing element PE11_S may output y₁₁ by adding partial sums multiplied by w₁₂, w₁₅, w₁₆, w₁ₘ and x₂₁, x₅₁, x₆₁, and xₘ₁, respectively. That is, the processing elements PE11_S may obtain the output element y₁₁ according to Equation 5 below.

$${y}_{11} = {w}_{12} \times {x}_{21} + {w}_{15} \times {x}_{51} + {w}_{16} \times {x}_{61} + {w}_{1 m} \times {x}_{m 1} \qquad ( Equation 5 )$$

In this way, each of the processing elements PE11_S to PE1b_S may calculate y₁₁ to y_{1b} respectively based on the order in which the plurality of residual weights RW and the input elements IE are received.

FIG. 11 is a block diagram illustrating the configuration and operation of the second processing element array of FIG. 8 in more detail. Referring to FIG. 1 to FIG. 8 and FIG. 11, the second processing element array 240_L may include a plurality of processing elements PE arranged in the row direction and the column direction.

The plurality of processing elements PE included in the second processing element array 240_L may be arranged in four rows and b columns. That is, the number of rows of the second processing element array 240_L may be the same as the number of rows of each plurality of large sub-matrices SM_L, and the number of columns of the second processing element array 240_L may be the same as the number of columns of the input matrix XM.

According to the embodiment of the disclosure, the size of the second processing element array 240_L may be larger than the size of the first processing element array 240_S. For example, the number of rows in second processing element array 240_L may be larger than the number of rows in first processing element array 240_S.

Hereinafter, a processing element arranged in an (i)-th row and a (j)-th column of the second processing element array 240_L will be referred to as “PEij_L”.

The second processing element array 240_L may include a first to fourth processing element row PER1_L to PER4_L. Each of the first to fourth processing element row PER1_L to PER4_L may include a plurality of different processing elements PE. For example, the first processing element row PER1_L may include processing elements PE11_L to PE1b_L.

The first to fourth processing element row PER1_L to PER4_L may receive residual weights RW arranged in different rows of the first pruned large sub-matrix PSM_L1. For example, an (i)-th processing element row PERi_L may receive residual weighs RW arranged in an (i)-th row of the first pruned large sub-matrix PSM_L1.

In more detail, each of processing elements included in the first processing element row PER1_L may receive w₃₁ and w₃₆ (e.g., residual weights included in the first row of the first pruned large sub-matrix PSM_L1). Similarly, each of processing elements included in the second processing element row PER2_S may receive w₄₁ and w₄₆; each of processing elements included in the third processing elements row PER3_S may receive w₅₁ and w₅₆; and each of processing elements included in the fourth processing element row PER4_S may receive w₆₁ and w₆₆.

A first to b-th processing element column PECb_L to PEC1_L may receive input elements IE arranged in different columns. For example, the first processing element column PEC1_L may receive input elements IE arranged in input element rows corresponding to the residual weight indexes RWI_PSM_L1 and a first input element column; and the second processing element column PEC2_S may receive input elements IE arranged in input element rows corresponding to the residual weight indexes RWI_PSM_L1 and a second input element column. In more detail, each of the processing elements included in the first processing element column PEC1_L may receive x₁₁ and x₆₁, and each of the processing elements included in the second processing element column PEC2_L may receive x₁₂ and x₆₂. In a similar way, the third to b-th processing element columns PEC3_L to PECb_L may be able to receive input elements IE arranged in different columns of the input matrix XM.

Each of the processing elements PE included in the second processing element array 240_L may output different output element based on the received plurality of residual weights RW and the received plurality of input elements IE. For example, the processing element PE11_L may output y₃₁ and the processing element PE12_L may output y₃₂. In this way, the first processing element row PER1_L may output y₃₁ to y_{3b}, and the fourth processing element row PER4_L may output y₄₁ to y_{4b}. That is, different processing element rows of the second processing element array 240_L may calculate output elements included in different rows of the output matrix; and different processing element columns of the second processing element array 240_L may calculate output elements included in different columns of the output matrix. The detailed method in which each processing element PE included in second processing element array 240_L obtains the output element will be described in more detail with reference to FIG. 12.

FIG. 12 illustrates the operation of the processing element row of FIG. 11 in more detail. That is, hereinafter, the operation of the first processing element row PER1_L will be representatively described with reference to FIG. 1 to FIG. 8 and FIG. 11 to FIG. 12. However, the scope of disclosure is not limited thereto, and other processing element rows included in second processing element array 240_L may also operate in a similar manner.

The first processing element row PER1_L may include processing elements PE11_L to PE1b_L. Each of the processing elements PE11_L to PE1b_L may sequentially receive residual weights RW_PSM_L1_R1 include in a first row of the first pruned large sub-matrix PSM_L1. That is, each of the processing elements PE11_L to PE1b_L may sequentially receive w₃₁ and w₃₆.

Each of the processing elements PE11_L to PE1b_L may sequentially receive input elements IE included in different columns of the input matrix XM. For example, the processing element PE11_L may sequentially receive input elements included in input element rows corresponding to the residual weight index RWI_PSM_L1 and the first input element column. In other words, the processing element PE11_L may sequentially receive x₁₁ and x₆₁. Similarly, the processing element PE12_L may sequentially receive x₁₂ and x₆₂ and the processing element PE1b_L may sequentially receive x_{1b} and x_{6b}.

Each of the processing elements PE11_L to PE1b_L may calculate different output element based on the order in which the plurality of residual weights RW and the input elements IE are received. For example, the processing elements PE11_L to PE1b_L may calculate y₃₁ to y_{3b}, respectively.

For more detailed example, the processing element PE11_L may output y₃₁ by adding partial sums multiplied by w₃₁ and w₃₆, and x₁₁ and x₆₁, respectively. In this way, each of the processing elements PE11_L to PE1b_L may calculate y₃₁ to y_{3b}, respectively, based on the order in which the plurality of residual weights RW and input elements IE are received.

In this way, the first processing element array 240_S may generate a plurality of small sub-output matrices SYM_S by multiplying each of the plurality of pruned small sub-matrices PSM_S with the input matrix XM. Similarly, the second processing element array 240_L may generate a plurality of large sub-output matrices SYM_L by multiplying each of the plurality of pruned large sub-matrices PSM_L with the input matrix XM. In this case, the plurality of small sub-output matrices SYM_S and the plurality of large sub-output matrices SYM_L may correspond to different rows of output matrix YM. In other words, a part of the weight matrix WM on which the second processing element array 240_L will perform a matrix multiplication operation with the input matrix XM may be different from a part of the weight matrix WM on which the first processing element array 240_S will perform a matrix multiplication operation with the input matrix XM.

FIG. 13 illustrates the operation of the output merging circuit of FIG. 6. Referring to FIG. 1 to FIG. 13, the output merging circuit 250 may receive the plurality of small sub-output matrices SYM_S and the plurality of large sub-output matrices SYM_L. For example, the output merging circuit 250 may sequentially receive the plurality of small sub-output matrices SYM_S from the first processing element array 240_S, and may sequentially receive the plurality of small sub-output matrices SYM_S from the second processing element array 240_L.

The output merging circuit 250 may generate an output matrix YM by merging the plurality of small sub-output matrices SYM_S and the plurality of large sub-output matrices SYM_L. In this case, row numbers in the output matrix YM corresponding to the plurality of small sub-output matrices SYM_S may be the same as row numbers in the weight matrix WM of the small sub-matrix SM_S, respectively corresponding to the plurality of small sub-output matrices SYM_S. For example, a first small sub-matrix SM_S1 used to generate a first small sub-output matrix SYM_S1 may correspond to first and second rows in the weight matrix WM. In this case, the first small sub-output matrix SYM_S1 may correspond to the first and second rows in the output matrix YM.

Similarly, row numbers in the output matrix YM corresponding to the plurality of large sub-output matrices SYM_L may be the same as row numbers in the weight matrix WM of the large sub-matrix SM_L, respectively corresponding to the plurality of large sub-output matrices SYM_L.

In this way, the arrangement order of the plurality of small sub-output matrices SYM_S and the plurality of large sub-output matrices SYM_L in the output matrix YM may correspond to the order of the plurality of small sub-matrices SM_S and the plurality of large sub-matrices SM_L described above with reference to FIG. 3.

Therefore, according to the embodiment of the disclosure, each of the plurality of small sub-output matrices SYM_S and the plurality of large sub-output matrices SYM_L may correspond to different rows of the output matrix YM. For example, the first small sub-output matrix SYM_S1 may correspond to the first to second rows of the output matrix YM, the first large sub-output matrix SYM_L1 may correspond to the third to sixth rows of the output matrix YM, and the second small sub-output matrix SYM_S2 may correspond to the third to sixth rows of output matrix YM.

According to the embodiment of the disclosure, the first processing element array 240_S and the second processing element array 240_L may sequentially calculate a part of the output matrix YM, and the output merging circuit 250 may generate the output matrix YM by merging results of calculation from the first processing element array 240_S and the second processing element array 240_L.

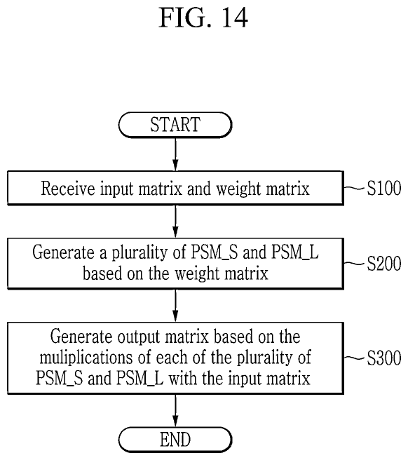

FIG. 14 is a flowchart of an operation method of the matrix multiplication system according to the embodiment of the disclosure. Referring to FIG. 1 to FIG. 14, in S100, the method may include receiving the input matrix XM and the weight matrix WM. For example, the matrix multiplication system MMS may receive the input matrix XM and the weight matrix WM. For example, the matrix multiplication device 200 may receive the input matrix XM, and the matrix pruning device 100 may receive the weight matrix WM.

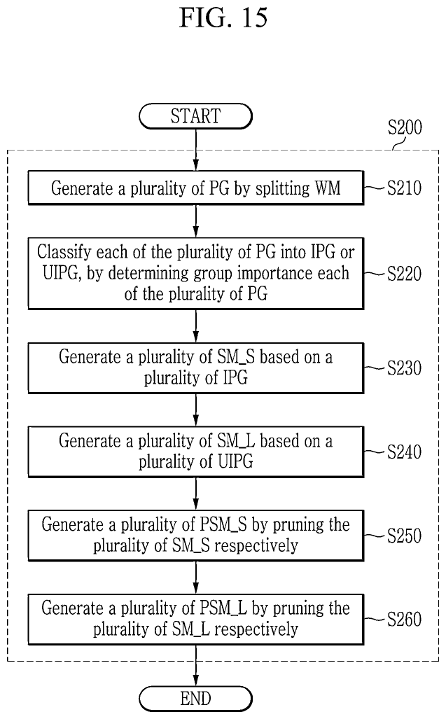

In S200, the method may include generating one or more pruned small sub-matrices PSM_S and one or more pruned large sub-matrices PSM_L based on the weight matrix WM. For example, the matrix multiplication system MMS may generate a plurality of pruned small sub-matrices PSM_S and a plurality of pruned large sub-matrices PSM_L based on the weight matrix WM. For example, the matrix pruning device 100 may generate the plurality of pruned small sub-matrices PSM_S and the plurality of pruned large sub-matrices PSM_L by pruning the weight matrix WM splitted into the plurality of pruning groups PG. The operation of the matrix pruning device 100 in S200 will be described in more detail with reference to FIG. 15.

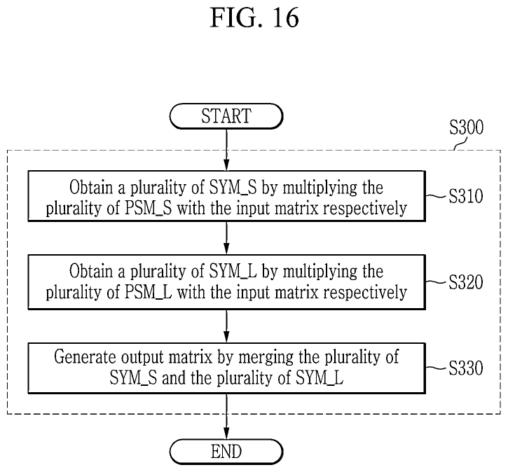

In S300, the method may include generating an output matrix YM based on multiplications of each of the plurality of pruned small sub-matrices PSM_S and the plurality of pruned large sub-matrices PSM_L with the input matrix XM. For example, the matrix multiplication system MMS may generate the output matrix YM based on multiplications of each of the plurality of pruned small sub-matrices PSM_S and the plurality of pruned large sub-matrices PSM_L with the input matrix XM. For example, the matrix multiplication device 200 may generate the output matrix YM by merging a result of multiplying the input matrix XM with the plurality of pruned small sub-matrices PSM_S and a result of multiplying the input matrix XM with the plurality of pruned large sub-matrices PSM_L. The operation of the matrix multiplication device 200 in S300 will be described in more detail with reference to FIG. 16.

FIG. 15 is a flowchart illustrating the operation S200 of FIG. 14 in more detail. Referring to FIG. 1 to FIG. 15, the operation S200 may include S210 to S260.

In S210, the method may include generating a plurality of pruning groups PG based on the weight matrix WM. For example, the matrix pruning device 100 may generate a plurality of pruning groups PG by splitting the weight matrix WM. For example, the matrix pruning device 100 may generate the plurality of pruning groups PG by splitting the weight matrix WM into two weight row units. However, the scope of the disclosure is not limited thereto, and the matrix pruning device 100 may generate the plurality of pruning groups PG by splitting the weight matrix WM into an arbitrary number of weight row units.

In S220, the method may include classifying each of the plurality of pruning groups PG into an important pruning group IPG or an unimportant pruning groups UIPG. For example, the matrix pruning device 100 may classify each of the plurality of pruning groups PG into an important pruning group IPG or an unimportant pruning groups UIPG by determining the group importance of each of the plurality of pruning groups PG. For example, the matrix pruning device 100 may obtain the group importance of each of the plurality of pruning groups PG. After obtaining the group importance of each of the plurality of pruning groups PG, the matrix pruning device 100 may classify pruning group PGs with group importance higher than a group importance threshold value GIPTH as important pruning groups IPG, and classify pruning group PGs with group importance lower than the group importance threshold value as unimportant pruning groups UIPG.

In S230, the method may include generating a plurality of small sub-matrices SM_S based on the plurality of important pruning groups IPG. For example, the matrix pruning device 100 may generate a plurality of small sub-matrices SM_S based on the plurality of important pruning groups IPG. For example, the matrix pruning device 100 may transform one important pruning group IPG into one small sub-matrix SM_S. However, the scope of the disclosure is not limited thereto, and the matrix pruning device 100 may generate one small sub-matrix SM_S by merging the plurality of important pruning groups IPG.

In an embodiment, each of the plurality of small sub-matrices SM_S may be a subset of the weight matrix WM. For example, each of the plurality of small sub-matrices SM_S may correspond to different important pruning group IPG in the weight matrix WM.

In S240, the method may include generating a plurality of large sub-matrices SM_L based on the plurality of unimportant pruning groups UIPG. For example, the matrix pruning device 100 may generate a plurality of large sub-matrices SM_L based on the plurality of unimportant pruning groups UIPG. For example, the matrix pruning device 100 may generate a plurality of large sub-matrices SM_L by generating one large sub-matrix SM_L by merging two unimportant pruning groups UIPG. However, the scope of the disclosure is not limited thereto, and the matrix pruning device 100 may generate one large sub-matrix SM_L by merging a random number of important pruning groups IPG.

In an embodiment, each of the plurality of large sub-matrices SM_L may be a subset of the weight matrix WM. For example, each of the plurality of large sub-matrices SM_L may correspond to two or more unimportant pruning groups UIPG in the weight matrix WM.

In S250, the method may include generating a plurality of pruned small sub-matrices PSM_S based on the plurality of small sub-matrices SM_S. For example, the matrix pruning device 100 may generate a plurality of pruned small sub-matrices PSM_S by pruning each of the plurality of small sub-matrices SM_S. For example, the matrix pruning device 100 may prune each of the plurality of small sub-matrices SM_S with column units.

In an embodiment, after S250, the matrix pruning device 100 may store the plurality of pruned small sub-matrices PSM_S in the weight memory circuit 210.

In S260, the method may include generate a plurality of pruned large sub-matrices PSM_L based on the plurality of large sub-matrices SM_L. For example, the matrix pruning device 100 may generate a plurality of pruned large sub-matrices PSM_L by pruning the plurality of large sub-matrices SM_L, respectively. For example, the matrix pruning device 100 may prune each of the plurality of large sub-matrices SM_L with column units.

In an embodiment, after S260, the matrix pruning device 100 may store the plurality of pruned large sub-matrices PSM_L in the weight memory circuit 210.

For a more concise explanation, in FIG. 15, an embodiment in which operations S230 to S260 are performed sequentially is representatively described, but the scope of the disclosure is not limited thereto. For example, S230 and S240 may be performed in parallel, and S250 and S260 may be performed in parallel.

FIG. 16 is a flowchart illustrating the operation S300 of FIG. 14 in more detail. Referring to FIG. 1 to FIG. 16, S300 may include S310 to S330.

In S310, the method may include obtaining the plurality of small sub-output matrices SYM_S based on the plurality of pruned small sub-matrices PSM_S and the input matrix XM. For example, the matrix multiplication device 200 may calculate the plurality of small sub-output matrices SYM_S by multiplying the plurality of pruned small sub-matrices PSM_S with the input matrix XM, respectively. For example, the matrix multiplication device 200 may calculate the first small sub-output matrix SYM_S1 corresponding to the product of the first pruned small sub-matrix PSM_S1 and the input matrix XM; and may calculate a second small sub-output matrix SYM_S2 corresponding to the product of the first pruned small sub-matrix PSM_S1 and the input matrix XM, by using the first processing element array 240_S.

In S320, the method may include obtaining the plurality of large sub-output matrices SYM_L based on the input matrix XM and the plurality of pruned large sub-matrices PSM_L. For example, the matrix multiplication device 200 may calculate the plurality of large sub-output matrices SYM_L by multiplying the input matrix XM and the plurality of pruned large sub-matrices PSM_L, respectively. For example, the matrix multiplication device 200 may calculate a first large sub-output matrix SYM_L1 corresponding to the product of the first pruned large sub-matrix PSM_L1 and the input matrix XM; and may calculate a second large sub-output matrix SYM_L2 corresponding to the product of the second pruned large sub-matrix PSM_L2 and the input matrix XM, by using the second processing element array 240_L.

For a more concise explanation, in FIG. 16, an embodiment in which the operations S310 to S320 are performed sequentially is representatively described, but scope of the disclosure is not limited thereto. For example, S310 may be performed in parallel with S320.

In S330, the method may include generating an output matrix YM based on the plurality of small sub-output matrices SYM_S and the plurality of large sub-output matrices SYM_L. For example, the matrix multiplication device 200 may generate an output matrix YM by merging the plurality of small sub-output matrices SYM_S and the plurality of large sub-output matrices SYM_L. For example, the output merging circuit 250 may generate the output matrix YM by merging the plurality of small sub-output matrices SYM_S and the plurality of large sub-output matrices SYM_L.

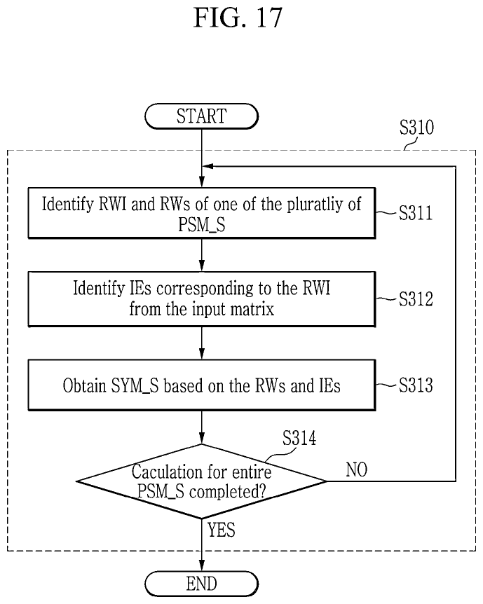

FIG. 17 is a flowchart illustrating the operation S310 of FIG. 16 in more detail. Referring to FIG. 1 to FIG. 17, the operation S310 may include S311 to S314.

In S311, the method may include identifying residual weights RW and a residual weight index RWI of a pruned small sub-matrix PSM_S among the plurality of pruned small sub-matrices PSM_S. For example, the matrix multiplication device 200 may identify residual weights RW and a residual weight index RWI of one pruned small sub-matrix PSM_S among the plurality of pruned small sub-matrices PSM_S. For example, the matrix multiplication device 200 may identify residual weights RW and a residual weight indexes RWI for one of the plurality of pruned small sub-matrices PSM_S stored in the weight memory circuit 210 which are stored with form of residual weights RW and residual weight indexes RWI.

In S312, the method may include identifying input elements IE corresponding to a residual weight index RWI from the input matrix XM. For example, the matrix multiplication device 200 may identify input elements IE corresponding to a residual weight index RWI from the input matrix XM. For example, the control logic circuit 220 may identify input elements IE included in input element rows corresponding to the residual weight indexes RWI identified in S311 described above.

In S313, the method may include obtaining the small sub-output matrix SYM_S based on the identified input elements IE and the residual weights RW. For example, the matrix multiplication device 200 may calculate the small sub-output matrix SYM_S based on the identified input elements IE and the residual weights RW. For example, the first processing element array 240_S may calculate a plurality of output elements included in one small sub-output matrix SYM_S, based on the residual weights RW identified in the operation S311 and the input elements IE identified in the operation S312.

In S314, the method may include determining whether the operation for all pruned small sub-matrices PSM_S has been completed. For example, the matrix multiplication device 200 may determine whether the operation for all pruned small sub-matrices PSM_S has been completed. For example, the matrix multiplication device 200 may determine whether small sub-output matrices SYM_S has been calculated based on each of all small sub-matrices PSM_S generated in operation S250 described above.

In S314, based on a determination that the calculation for any pruned small sub-matrix PSM_S has not been completed, the above-described operation S311 may be iteratively performed. In this way, the first processing element array 240_S may be able to sequentially generate a plurality of small sub-output matrices SYM_S corresponding to a product of the input matrix XM with each of the plurality of pruned small sub-matrices PSM_S.

In S314, based on a determination that the calculation for all pruned small sub-matrices PSM_S has been completed, the operation S310 may be terminated.

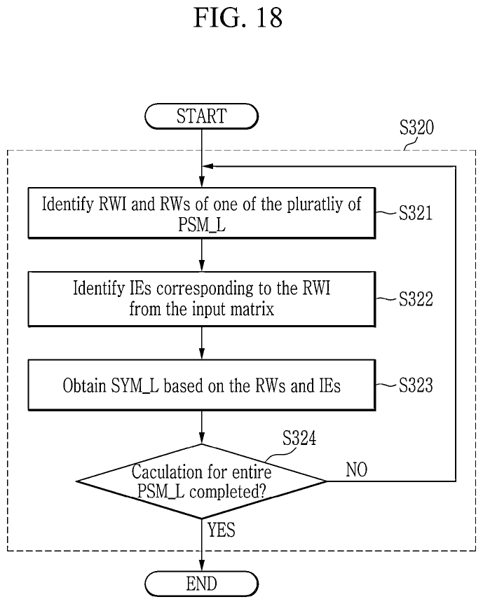

FIG. 18 is a flowchart illustrating the operation S320 of FIG. 16 in more detail. Referring to FIG. 1 to FIG. 18, the S320 may include S321 to S324.

In S321, the method may include identifying residual weights RW and residual weight indexes RWI of a pruned large sub-matrix PSM_L among the plurality of pruned large sub-matrices PSM_L. For example, the matrix multiplication device 200 may identify residual weights RW and residual weight indexes RWI of a pruned large sub-matrices PSM_L among the plurality of pruned large sub-matrices PSM_L. For example, the matrix multiplication device 200 may identify residual weights RW and residual weight indexes RWI for one of the plurality of pruned large sub-matrices PSM_L stored in form of the residual weight RW and the residual weight index RWI in the weight memory circuit 210.

In S322, the method may include identifying input elements IE corresponding to the residual weight indexes RWI from the input matrix XM. For example, the matrix multiplication device 200 may identify input elements IE corresponding to the residual weight indexes RWI from the input matrix XM. For example, the control logic circuit 220 may identify input elements IE included in input element rows corresponding to the residual weight indexes RWI identified in operation S321 described above.

In S323, the method may include obtaining large sub-output matrices SYM_L based on the identified input elements IE and residual weights RW. For example, the matrix multiplication device 200 may calculate large sub-output matrices SYM_L based on the identified input elements IE and residual weights RW. For example, the second processing element array 240_L may calculate a plurality of output elements included in one large sub-out matrix SYM_L, based on the residual weights RW identified in S321 and the input elements IE identified in S322.

In S324, the method may include determining whether the calculation for all pruned large sub-matrices PSM_L has been completed. For example, the matrix multiplication device 200 may determine whether the calculation for all pruned large sub-matrices PSM_L has been completed. For example, the matrix multiplication device 200 may determine whether large sub-output matrix SYM_L has been calculated based on each of all large sub-matrices PSM_L generated in operation S260 described above.

In S324, based on a determination that the calculation for any pruned large sub-matrix PSM_L is not completed, the above-described operation S321 may be performed repeatedly. In this way, the second processing element array 240_L may be able to sequentially generate a plurality of large sub-output matrices SYM_L corresponding to a product of the input matrix XM with each of the plurality of pruned large sub-matrices PSM_L.

In S324, based on a determination that the operation for all the pruned large sub-matrices PSM_L has been completed, the operation S320 may be terminated.

According to an embodiment of the disclosure, the first processing element array 240_S may sequentially generate the plurality of small sub-output matrices SYM_S based on the plurality of pruned small sub-matrices PSM_S, and the second processing element array 240_L may sequentially generate the plurality of large sub-output matrices SYM_L based on the plurality of pruned large sub-matrices PSM_L. For example, the first processing element array 240_S and the second processing element array 240_L each operates in parallel and may obtain different parts of the output matrix YM.

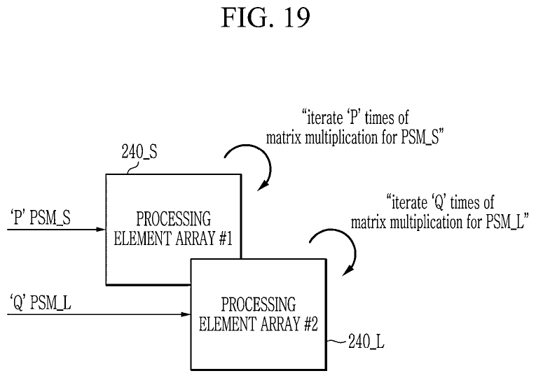

FIG. 19 illustrates the iterative operation of the processing element arrays of FIG. 6. Referring to FIG. 1 to FIG. 19, the first processing element array 240_S may sequentially receive ‘P’ pruned small sub-matrices PSM_S. The second processing element array 240_L may sequentially receive ‘Q’ pruned large sub-matrices PSM_L. Here, ‘P’ and ‘Q’ are integers.

In an embodiment, a value obtained by adding P times the number of rows of the pruned small sub-matrix PSM_S and Q times the number of rows of the pruned large sub-matrix PSM_L may be the same as the number of rows of the weight matrix WM (i.e., n). For example, the ‘P’ pruned small sub-matrices PSM_S and the ‘Q’ pruned large sub-matrices PSM_L may be respectively generated by pruning ‘P’ small sub-matrices SM_S and ‘Q’ large sub-matrices SM_L, which are generated based on one weight matrix WM.

The first processing element array 240_S may perform matrix multiplication for each of the ‘P’ pruned small sub-matrices PSM_S. For example, the first processing element array 240_S may generate ‘P’ small sub-output matrices SYM_S respectively corresponding to products of the input matrix XM with each of the ‘P’ pruned small sub-matrices PSM_S. For example, the first processing element array 240_S may iteratively perform the matrix multiplication (e.g., the matrix multiplication described with reference to FIG. 9 and FIG. 10) ‘P’ times for generating the small sub-output matrix SYM_S corresponding to the product of one pruned small sub-matrix PSM_S and the input matrix XM.

Similarly, the second processing element array 240_L may perform a matrix multiplication operation for each of the ‘Q’ pruned large sub-matrices PSM_L. For example, the second processing element array 240_L may generate ‘Q’ large sub-output matrices SYM_L respectively corresponding to the products of the input matrix XM for each of the ‘Q’ pruned large sub-matrices PSM_L. For example, the second processing element array 240_L may iteratively perform the matrix multiplication (e.g., the matrix multiplication described with reference to FIG. 11 and FIG. 12) ‘Q’ times for generating the large sub-output matrix SYM_L corresponding to the product of one pruned large sub-matrix PSM_L and the input matrix XM.

The first processing element array 240_S and the second processing element array 240_L may operate in parallel with each other. For example, the first processing element array 240_S and the second processing element array 240_L may independently perform ‘P’ times of matrix multiplication operations and ‘Q’ times of matrix multiplication operations, respectively. However, the disclosure is not limited thereto, and as such, according to another embodiment, the first processing element array 240_S and the second processing element array 240_L may operate in a sequential order.

Hereinafter, for a more concise description, a total time taken for the first processing element array 240_S to perform the matrix multiplication operation ‘P’ times may be referred to as a first operation time, and a total time taken for the second processing element array 240_L to perform the matrix multiplication operation ‘Q’ times may be referred to as a second operation time.

In an example case in which the operation times of the first processing element array 240_S and the second processing element array 240_L are synchronized, the matrix multiplication operations of the first processing element array 240_S and the second processing element array 240_L may start and end simultaneously. That is, in an example case in which the first operation time and the second operation time are synchronized, the operation efficiency of the matrix multiplication system MMS can be maximized.

For a more detailed example, in a case in which ‘P’ and ‘Q’ are the same, the first operation time and the second operation time can be synchronized, and a time taken for the first processing element array 240_S to perform one matrix multiplication operation and a time taken for the second processing element array 240_L to perform one matrix multiplication operation are the same. However, the scope of the disclosure is not limited thereto.

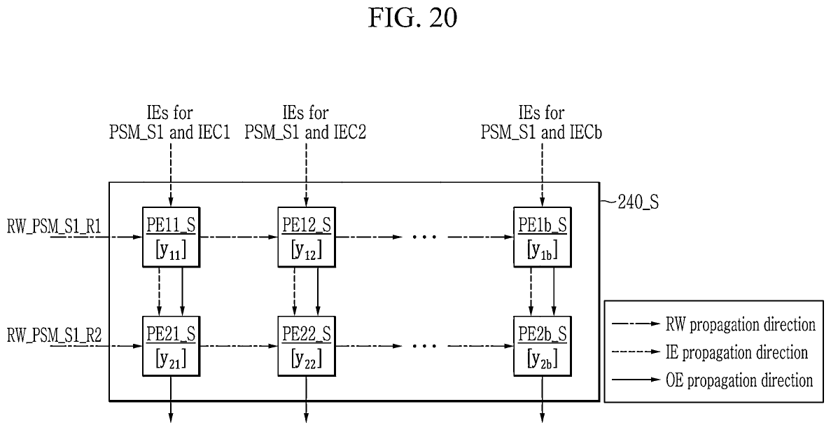

Hereinafter, referring to FIG. 20 to FIG. 25, a method for synchronizing the first operation time and the second operation time will be described in detail.

FIG. 20 is a block diagram illustrating the processing element array of FIG. 19 implemented with systolic array scheme. Hereinafter, referring to FIG. 20, a configuration and operation of the first processing element array 240_S of FIG. 19, implemented with the systolic array scheme will be representatively described, but the scope of the disclosure is not limited thereto. For example, the second processing element array 240_L may also be implemented using the systolic array scheme. According to another embodiment, the first processing element array 240_S and the second processing element array 240_L may be implemented using another scheme.

Referring to FIG. 1 to FIG. 20, the first processing element array 240_S may include a plurality of processing elements PE arranged in a row direction and a column direction. For example, the processing elements PE may include, but is not limited to, PE11_1, PE12_S, to PE1b_S and PE21_S, PE22_S, to PE2b_S. The plurality of processing elements PE may operate in the systolic array method.

The first processing element array 240_S may sequentially receive a residual weights RW_PSM_S1 included in the first pruned small sub-matrix PSM_S1. The first processing element array 240_S may be implemented to propagate the residual weights RW_PSM_S1 sequentially in the row direction. For example, the first processing element row PER1_S may sequentially propagate residual weights RW_PSM_S1_R1 (e.g., w₁₂, w₁₅, w₁₆, w₁ₘ) included in a first row of the first pruned small sub-matrix PSM_S1 in the row direction.

For a more detailed example, the processing element PE11_S may receive one residual weight RW at a 0-th time point. The processing element PE11_S may receive a different residual weight RW at a first time point after the 0-th time point. The processing element PE11_S may transmit the residual weight RW received at the 0-th time point to the processing element PE12_S located adjacent to the processing element PE11_S in the row direction at the first time point.

In this way, the processing elements PE included in the first processing element row PER1_S may sequentially transmit a plurality of residual weights RW (e.g., residual weights RW_PSM_S1_R1 included in the first row of the first pruned small sub-matrix PSM_S1) provided from the weight memory circuit 210 to adjacent processing elements.

Similarly, the second processing element row PER2_S may sequentially propagate the plurality of residual weights RW (e.g., residual weights RW_PSM_S1_R2 included in the second row of the first pruned small sub-matrix PSM_S1) provided from the weight memory circuit 210 in the row direction.

Meanwhile, a time point when the second processing element row PER2_S initially receives residual weights RW may be later than a time point when the first processing element row PER1_S initially receives residual weights RW. For example, the processing element PE21_S may initially receive residual weights RW at the first time point after the 0-th time point.

The first processing element array 240_S may be implemented to sequentially propagate the plurality of input elements IE in the column direction. For example, the first processing element column PEC1_S may sequentially propagate input elements (e.g., x₂₁, x₅₁, x₆₁, and xₘ₁) for a first input element column IEC1 and the first pruned small sub-matrix PSM_S1 in the column direction.

For a more detailed example, the processing element PE11_S may receive one input element IE at the 0-th time point, and may further receive another input element IE at the first time point after the 0-th time point. The processing element PE11_S may transmit the input element received at the 0-th time point to the processing element PE21_S provided adjacent to the processing element PE11_S in the column direction at the first time point.

In this way, the processing elements PE included in the first processing element column PEC1_S may sequentially transmit the plurality of input elements IE provided from the input matrix buffer 230 to adjacent processing elements. Similarly, each of the second to b-th processing element column PEC2_S to PECb_S may sequentially propagate the plurality of input elements IE provided from the input matrix buffer 230 in the column direction.

Meanwhile, the first processing element column PEC1_S to the b-th processing element column PECb_S may initially receive the input element IE at different time points. For example, a time point when the second processing element column PEC2_S initially receives the input element IE may be later than a time point when the first processing element column PEC1_S initially receives the input element IE. For example, the processing element PE21_S may initially receive the input element IE at the first time point after the 0-th time point, and the processing element PE31_S may initially receive the input element IE at a second time point after the first time point.

Each of the plurality of processing elements PE may generate different output elements OE similar to the method described above with reference to FIG. 9 to FIG. 10. For example, each of the plurality of processing elements PE may generate a different output element OE by accumulating products of the input element IE and the residual weights RW received at identical time point.

The first processing element array 240_S may be implemented to propagate the obtained output element OE sequentially in the column direction. For example, an output element OE (e.g., y₁₁) calculated by the processing element PE11_S may be propagated sequentially in the column direction. In this way, the output element OE calculated by each processing element PE may be transmitted to the output merging circuit 250. A method for the output element OE is propagated is similar to the method for the input element IE is propagated, and therefore no further detailed description will be provided.

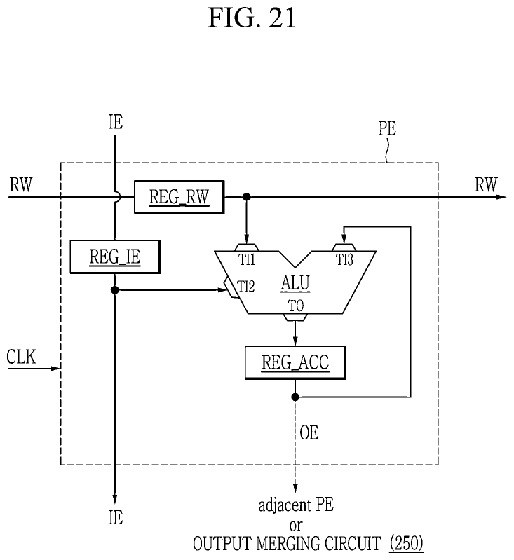

For example, each of the processing elements included in the first processing element array 240_S may be implemented to receive one or more of the input element IE, the residual weight RW, and the output element OE from a processing element located adjacent to the first processing element array 240_S. Moreover, each of the processing elements included in the first processing element array 240_S may be implemented to transmit one or more of the input element IE, the residual weight RW, and the output element OE to a processing element located adjacent to each other. A more detailed configuration and operation of each of the plurality of processing elements PE will be described in more detail with reference to FIG. 21.

For a more concise explanation, in FIG. 20, an embodiment in which the input element IE, the residual weight RW, and the output element OE are all propagated in a systolic array scheme is representatively illustrated, but the scope of the disclosure is not limited thereto. For example, the first processing element array 240_S may be implemented to propagate only some of the input element IE, the residual weight RW, and the output element OE in a systolic array scheme.

In an embodiment, each of the processing elements included in the first processing element array 240_S may calculate based on the same control clock signal. In this case, each of the plurality of processing elements may transmit the input element IE, the residual weight RW, and/or the output element OE to other processing elements at the same time point. However, the scope of the disclosure is not limited thereto.

FIG. 21 illustrates the configuration of the processing element of FIG. 20 in more detail. Referring to FIG. 1 to FIG. 21, the processing elements PE may include an arithmetic logic unit ALU, an accumulation register REG_ACC, a residual weight register REG_RW, and an input element register REG_IE. The arithmetic logic unit ALU may include a first input terminal T11, a second input terminal T12, a third input terminal T13 and an output terminal TO.

The residual weight register REG_RW may receive the plurality of residual weights RW. For example, the residual weight register REG_RW may sequentially receive the plurality of residual weights RW. The residual weight register REG_RW may receive residual weights RW and transmit the residual weights RW to adjacent processing elements PE and a first input terminal T11 after one cycle of a control clock signal CLK has elapsed.

The input element register REG_IE may receive a plurality of input elements IE. For example, the input element register REG_IE may sequentially receive a plurality of input elements IE. The input element register REG_IE may receive one input element IE and transmit the one input element IE to the adjacent processing elements PE and a second input terminal T12 after one cycle of the control clock signal CLK has elapsed.

The arithmetic logic unit ALU may receive the plurality of residual weights RW through the first input terminal T11 and the plurality of input elements IE through the second input terminal T12. For example, the arithmetic logic unit ALU may sequentially receive the plurality of residual weights RW through the first input terminal T11, and may sequentially receive the plurality of input elements IE through the second input terminal T12.

The third input terminal T13 may be connected to the accumulation register REG_ACC. The arithmetic logic unit ALU may receive data stored in the accumulation register REG_ACC through the third input terminal T13.

The arithmetic logic unit ALU may calculate a value by adding the product of the residual weights RW received through the first input terminal T11 and the input element IE received through the second input terminal T12 to the data received through the third input terminal T13. The arithmetic logic unit ALU may update a value stored in the accumulation register REG_ACC by providing the calculated value to the accumulation register REG_ACC through the output terminal TO. In other words, the arithmetic logic unit ALU may update the calculated value in the accumulation register REG_ACC through Equation 6 below.

$$ACC\_post = IEin \times RWin + ACC\_pre \qquad ( Equation 6 )$$

Here, IEin may refer to an input element IE received through the second input terminal T12 by the arithmetic logic unit ALU, RWin may refer to residual weights RW received through the first input terminal T11 by the arithmetic logic unit ALU, ACC_pre may refer to an accumulation value received from the accumulation register REG_ACC through the third input terminal T13 by the arithmetic logic unit ALU, and ACC_post may refer to a value updated to the accumulation register REG_ACC by calculation of the arithmetic logic unit ALU.

In an embodiment, the product of IEin and RWin may be referred to as a partial sum (hereinafter referred to as PSUM).

That is, the arithmetic logic unit ALU may sequentially accumulate partial sums corresponding to the products of the residual weights RW received through the first input terminal T11 and the input element IE received through the second input terminal T12 respectively. In this way, the arithmetic logic unit ALU may obtain an output element OE by accumulating a plurality of partial sums in the accumulation register REG_ACC.

The accumulation register REG_ACC may store the output element OE calculated by the arithmetic logic unit ALU. The accumulation register REG_ACC may provide the output element OE to the output merging circuit 250 in a systolic array scheme. In other words, the accumulation register REG_ACC may transfer the output element OE to the adjacent processing elements PE or to the output merging circuit 250.

For a more detailed example, the output element OE (e.g., y₁₁) calculated by a processing element PE11_S may be transmitted to the output merging circuit 250 through processing elements PE21_S. However, the scope of the disclosure is not limited thereto.

In an embodiment, the accumulation register REG_ACC may transmit the output element OE to the accumulation register of adjacent processing elements PE. However, the scope of disclosure is not limited thereto, and the accumulation register REG_ACC may also transmit the output element OE to a separate output element register included in adjacent processing elements PE.

The arithmetic logic unit ALU, the accumulation register REG_ACC, the residual weight register REG_RW, and the input element register REG_IE each may operate based on the control clock signal CLK. In this case, the arithmetic logic unit ALU may accumulate partial sums in the accumulation register REG_ACC for each cycle of the control clock signal CLK; and the accumulation register REG_ACC, the residual weight register REG_RW, and the input element register REG_IE each may update stored data every cycle of the control clock signal CLK.

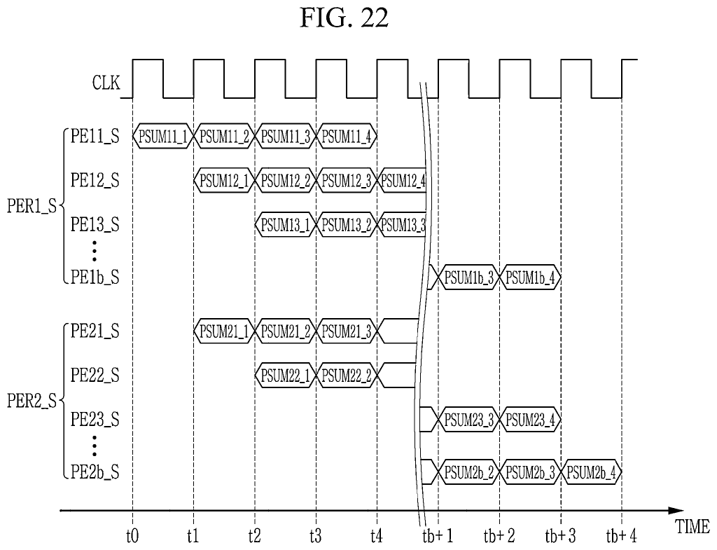

FIG. 22 is a timing diagram illustrating the operation of each of the processing elements of FIG. 20. Referring to FIG. 1 to FIG. 22, each of the plurality of processing elements PE included in the first processing element array 240_S may operate based on the control clock signal CLK.

Hereinafter, for a more concise description, it is assumed that an interval between each time point from a 0-th time point t0 to a (b+4)-th time point tb+4 is the same as the period of the control clock signal CLK. However, the scope of disclosure is not limited thereto, and the intervals between the 0-th time point t0 and the (b+4)-th time point tb+4 may be integer times of the cycle of the control clock signal CLK.

For example, at the 0-th time point t0, the processing element PE11_S may accumulate a partial sum PSUM11_1 corresponding to the product of w₁₂ and x₂₁ to the accumulation register REG_ACC. Next, at a first time point t1, the processing element PE11_S may further accumulate a partial sum PSUM11_2 corresponding to the product of w₁₅ and x₅₁ to the accumulation register REG_ACC. In this way, at the second time point t2 and a third time point t3, the processing element PE11_S may sequentially accumulate a partial sum PSUM11_3 and a partial sum PSUM11_4 in the accumulation register REG_ACC. In this case, an output element y₁₁ will be stored in the accumulation register REG_ACC of the processing element PE11_S after the third time point t3.

Meanwhile, the processing element PE12_S may receive a residual weight RW and an input element IE one period of control clock signal CLK later than the processing element PE11. Accordingly, the processing element PE12_S may accumulate a partial sum PSUM21_1 corresponding to the product of w₂₂ and x₂₁ in the accumulation register REG_ACC at the first time point t1, which is later than the 0-th time point t0. In this way, the processing element PE12_S may be able to sequentially receive the plurality of residual weights RW and the input element IE and generate an output element y₁₂ at a fourth time point t4, which is later than the third time point t3.

Similarly, a processing element PE1b_S may receive a residual weight RW and an input element IE (b−1) times as later as the cycle of the control clock signal CLK than the processing element PE11_S. Accordingly, the processing element PE1b_S may generate an output element y_{1b} at a (b+2)-th time point tb+2.

Meanwhile, a time point at which the processing elements PE21_S to PE2b_S included in the second processing element row PER2_S initially receives the residual weight RW and the input element IE may be delayed by one cycle of the control clock signal CLK than a time point at which the processing elements PE11_S to PE1b_S included in the first processing element row PER1_S initially receive the residual weight RW and the input element IE. For example, the processing element PE21_S may receive the residual weight RW and the input element IE one cycle of the control clock signal CLK later than the processing element PE11_S, and the processing element PE2b_S may receive the residual weight RW and the input element IE one cycle of the control clock signal CLK later than the processing element PE1b_S. Accordingly, the processing element PE2b_S may generate an output element y_{2b} at a (b+3)-th time point tb+3.

That is, a time taken for the first processing element array 240_S to perform one matrix multiplication operation to generate a small sub-output matrix SYM_S corresponding to the product of one pruned small sub-matrix PSM_S and an input matrix XM may be determined based on the sum of: i) the number of columns including the residual weight RW of the pruned small sub-matrix PSM_S, ii) the number of columns of the input matrix XM (e.g., the number of columns of the first processing element array 240_S), and iii) the number of rows of the pruned small sub-matrix PSM_S (e.g., the number of rows of the first processing element array 240_S).

Similarly, a time taken for the second processing element array 240_L to perform one matrix multiplication operation to generate a large sub-output matrices SYM_L corresponding to the product of one pruned small sub-matrix PSM_S and an input matrix XM may be determined based on the sum of: i) the number of columns including the residual weight RW of the pruned large sub-matrix PSM_L, ii) the number of columns of the input matrix XM (e.g., the number of columns of the second processing element array 240_L), and iii) the number of rows of the pruned large sub-matrix PSM_L (e.g., the number of rows of the second processing element array 240_L).

Therefore, the first operation time described with reference to FIG. 19 may be determined by adjusting the size of “P” and/or the number of columns including the residual weight RW of the pruned small sub-matrix PSM_S. Similarly, the second operation time described with reference to FIG. 19 may be determined by adjusting the size of “Q” and/or the number of columns including the residual weight RW of the pruned large sub-matrix PSM_L.

In an example case in which “P” and “Q” described with reference to FIG. 19 are the same, the first operation time and the second operation time may be synchronized when the sum of the number of columns including the residual weight RW of the pruned small sub-matrix PSM_S and the number of rows of the pruned small sub-matrix PSM_S is the same as the sum of the number of columns including the residual weight RW of the pruned large sub-matrix PSM_L and the number of rows of the pruned large sub-matrix PSM_L.

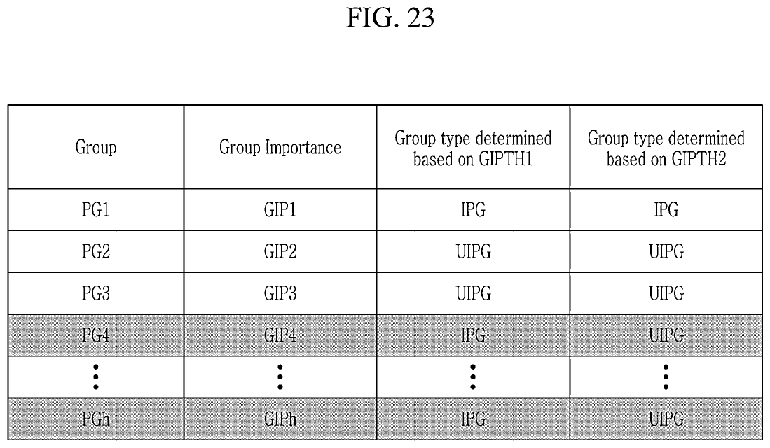

FIG. 23 illustrates a method for adjusting the operation time of the processing element arrays of FIG. 19 according to an embodiment. Referring to FIG. 1, FIG. 3, FIG. 19, and FIG. 23, the matrix pruning device 100 may split the weight matrix WM into a first to h-th pruning group PG1 to PGh. The matrix pruning device 100 may calculate the group importance of each of the first to h-th pruning groups PG1 to PGh. In this case, group importance information of the first to h-th pruning groups PG1 to PGh may be GIP1 to GIPh respectively. The method in which the matrix pruning device 100 calculates the group importance of each of the first to h-th pruning groups PG1 to PGh has been described previously with reference to FIG. 3, and therefore no detailed description will be provided.

In an embodiment, the matrix pruning device 100 may classify group type from of the first to h-th pruning group PG1 to PGh based on the first group importance threshold value GIPTH1. In this case, pruning groups with group importance higher than a first group importance threshold value GIPTH1 may be classified as an important pruning group IPG, and pruning groups with group importance lower than the first group importance threshold value GIPTH1 may be classified as an unimportant pruning group UIPG. For a more detailed example, in a case in which GIP1, GIP4, and GIPh are higher than the first group importance threshold value GIPTH1, the first pruning group PG1, the fourth pruning group PG4, and the h-th pruning group PGh may be classified as the important pruning groups IPG. In an example case in which GIP2 and GIP3 are lower than the first group importance threshold value GIPTH1, the second pruning group PG2 and the third pruning group PG3 may be classified as the unimportant pruning groups UIPG.

In an embodiment, the matrix pruning device 100 may classify group type of the first to h-th pruning group PG1 to PGh based on a second group importance threshold value GIPTH2. In this case, the number of pruning groups classified as the important pruning group IPG may be changed compared to the case of classifying the group type of each group of the first to h-th pruning group PG1 to PGh based on the first group importance threshold value GIPTH1. For example, in a case in which GIP4 and GIPh are higher than the first group importance threshold value GIPTH1 and lower than the second group importance threshold value GIPTH2, the fourth and h-th pruning groups PG4 and PGh may be classified as the unimportant pruning groups UIPG based on the matrix pruning device 100 classifying the group type of each of the first to h-th pruning group PG1 to PGh based on the second group importance threshold value GIPTH2.

According to an embodiment of the disclosure, matrix pruning device 100, the number of pruning groups classified as the important pruning group IPG and the unimportant pruning groups UIPG may vary based on what group importance threshold value the matrix pruning device 100 classifies each group type from the first to h-th pruning group PG1 to PGh. In other words, since the number of plurality of small sub-matrices SM_S and the number of plurality of large sub-matrices SM_L may be changed by adjusting the group importance threshold value, the number of plurality of pruned small sub-matrices PSM_S and the number of plurality of pruned large sub-matrices PSM_L may be adjusted. In this case, the number of times the first processing element array 240_S performs matrix multiplication operation (e.g., ‘P’ as described referring to FIG. 19) and the number of times the second processing element array 240_L performs matrix multiplication operation (e.g., ‘Q’ as described referring to FIG. 19) can be adjusted, and therefore the first operation time and the second operation time may be synchronized. Therefore, the operational efficiency of the matrix multiplication system MMS can be optimized by adjusting the group importance threshold value.

FIG. 24 illustrates a method for adjusting the operation time of the processing element arrays of FIG. 19 according to an embodiment. Referring to FIGS. 1, 3, 4, 5, 19 and 24, the matrix pruning device 100 may generate a plurality of small sub-matrices SM_S and a plurality of large sub-matrices SM_L based on the weight matrix WM. The matrix pruning device 100 may generate a plurality of pruned small sub-matrices PSM_S by pruning each of the plurality of small sub-matrices SM_S, and may generate a plurality of pruned large sub-matrices PSM_L by pruning each of the plurality of large sub-matrices SM_L.

The matrix pruning device 100 may prune each of the plurality of small sub-matrices SM_S with the same pruning ratio. In this case, the number of columns including residual weight of each of the plurality of pruned small sub-matrices PSM_S may be the same.

The matrix pruning device 100 may prune each of the plurality of large sub-matrices SM_L with the same pruning ratio. In this case, the number of columns including residual weight of each of the plurality of pruned large sub-matrices PSM_L may be the same.

The matrix pruning device 100 may adjust a pruning ratio for the plurality of small sub-matrices SM_S or a pruning ratio for the plurality of large sub-matrices SM_L. Hereinafter, for a more concise description, an embodiment in which the matrix pruning device 100 adjusts a pruning ratio for the plurality of small sub-matrices SM_S will be representatively described. However, the scope of the disclosure is not limited thereto, and the matrix pruning device 100 may be able to adjust the pruning ratio for the plurality of small sub-matrices SM_S and/or the plurality of large sub-matrices SM_L in a similar manner.

The matrix pruning device 100 may calculate column importance of each of the plurality of pruning units PU included in the first small sub-matrix SM_S1. In this case, the column importance of the pruning units PU corresponding to a first to m-th columns of the first small sub-matrix SM_S1 may be CIP1 to CIPh, respectively. A method in which the matrix pruning device 100 calculates the column importance of each of the plurality of pruning units PU is previously described in with reference to FIG. 4 to FIG. 5, and therefore no further detailed description will be provided.

In an embodiment, the matrix pruning device 100 may prune the plurality of pruning units PU included in the first small sub-matrix SM_S1 based on a first pruning ratio PRR1. For example, the matrix pruning device 100 may maintain top four pruning units having the highest column importance among the plurality of pruning units PU included in the first small sub-matrix SM_S1, and may transform weights of the remaining pruning units to zero elements. For a more detailed example, in a case in which the column importance information of the top four pruning units among CIP1 to CIPh are CIP2, CIP5, CIP6, and CIPm respectively, the matrix pruning device 100 may maintain weights included in the second, fifth, sixth, and m-th columns of the first small sub-matrix SM_S1 and transform weights included in the remaining columns to zero elements.

In an embodiment, the matrix pruning device 100 may prune the plurality of pruning units PU included in the first small sub-matrix SM_S1 based on a second pruning ratio PRR2. For example, the matrix pruning device 100 maintain top three pruning units having the highest column importance among the plurality of pruning units PU included in the first small sub-matrix SM_S1, and may transform weights of the remaining pruning units to zero elements. For a more detailed example, in a case in which the column importance of the top three pruning units among CIP1 to CIPh are CIP2, CIP5, and CIP6 respectively, the matrix pruning device 100 may maintain weights included in the second, fifth, and sixth columns of the first small sub-matrix SM_S1 and transform weights included in the remaining columns to zero elements. In other words, in a case in which the matrix pruning device 100 prunes the plurality of pruning units PU included in the first small sub-matrix SM_S1 based on the second pruning ratio PRR2, the number of columns including the residual weight of the first pruned small sub-matrix PSM_S1 may decrease.

According to the embodiment of the disclosure, the number of the residual weight included in the plurality of pruned small sub-matrices PSM_S may vary depending on which pruning ratio is used by the matrix pruning device 100 to prune the plurality of small sub-matrices SM_S. In other words, the number of partial sums to be calculated by each processing element included in the first processing element array 240_S may be changed by adjusting the pruning ratio for the plurality of small sub-matrices SM_S. Therefore, time taken for the first processing element array 240_S to perform a matrix multiplication operation for one small sub-matrix SM_S and the input matrix XM can be adjusted, and therefore the first operation time described previously with reference to FIG. 19 may be adjusted.

Similarly, depending on what pruning ratio is used by the matrix pruning device 100 to prune the plurality of small sub-matrices SM_S, time taken for the second processing element array 240_L to perform a matrix multiplication operation for one large sub-matrix SM_L and an input matrix XM can be adjusted, and therefore the second operation time described above with reference to FIG. 19 can be adjusted.

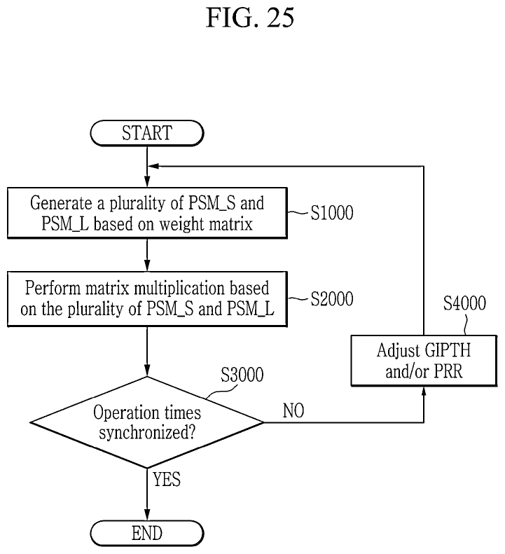

FIG. 25 is a flowchart of a method for synchronizing the operation times of the processing element arrays of FIG. 19. Referring to FIG. 1 to FIG. 25, in S1000, the method may include generating one or more pruned small sub-matrices PSM_S and one or more pruned large sub-matrices PSM_L based on the weight matrix WM. For example, the matrix multiplication system MMS may generate a plurality of pruned small sub-matrices PSM_S and a plurality of pruned large sub-matrices PSM_L based on the weight matrix WM. The operation S1000 is similar to the operation S200 described with reference to FIG. 14, and therefore no further detailed description will be provided.

In S2000, the method may include performing a matrix multiplication operation based on the pruned small sub-matrices PSM_S and the pruned large sub-matrices PSM_L. For example, the matrix multiplication system MMS may perform a matrix multiplication operation based on the plurality of pruned small sub-matrices PSM_S and the plurality of pruned large sub-matrices PSM_L. For example, the matrix multiplication system MMS may calculate an output matrix YM corresponding to the product of the weight matrix WM and the input matrix XM by calculating the product of the plurality of pruned small sub-matrices PSM_S and the plurality of pruned large sub-matrices PSM_L for the input matrix XM. In more detail, the matrix multiplication system MMS may calculate the product for the input matrix XM of each of the plurality of pruned small sub-matrices PSM_S using a first processing element array 240_S, and may calculate the product for the input matrix XM for each of the plurality of pruned large sub-matrices PSM_L using a second processing element array 240_L.

In S3000, the method may include determining whether the operation times of a first processing element array 240_S and a second processing element array 240_L are synchronized. For example, the matrix multiplication system MMS may determine whether the operation times are synchronized. For example, the matrix multiplication system MMS may determine whether the first operation time taken for the first processing element array 240_S to generate the plurality of small sub-output matrix SYM_S is the same as the second operation time taken for the second processing element array 240_L to generate the plurality of large sub-output matrices SYM_L. In other words, the matrix multiplication system MMS may determine whether or not a time consumed to complete outputting the plurality of small sub-output matrix SYM_S by the first processing element array 240_S is the same as a time consumed to complete outputting the plurality of large sub-output matrices SYM_L by the second processing element array 240_L.

In S3000, based on a determination that the operation times are synchronized, the operation of the matrix multiplication system MMS may be terminated.

In S3000, based on a determination that the operation times are not synchronized, the matrix multiplication system MMS may perform the operation S4000.

In S4000, the method may include adjusting the group importance threshold value GIPTH and/or the pruning ratio PRR. For example, the matrix multiplication system MMS may adjust the group importance threshold value GIPTH and/or the pruning ratio PRR based on a determination that the operation times are not synchronized. For example, the matrix multiplication system MMS may adjust the number of plurality of pruned small sub-matrices PSM_S and the number of plurality of pruned large sub-matrices PSM_L by adjusting the group importance threshold value GIPTH. In additionally or alternatively, the matrix multiplication system MMS may adjust the number of partial sums to be obtained by one processing element by adjusting the pruning ratio for plurality of small sub-matrices SM_S or plurality of large sub-matrices SM_L. After then, the above-described S1000 may be iteratively performed.

In this way, the matrix multiplication system MMS may synchronize the first operation time and the second operation time. In this case, the operation times of the first processing element array 240_S and the second processing element array 240_L are synchronized, and thus the operation efficiency of the matrix multiplication system MMS can be maximized.

In an example case in which the sum of the number of rows of the first processing element array 240_S and the number of columns including the residual weights in the plurality of pruned small sub-matrices PSM_S is the same as the sum of the number of rows of the second processing element array 240_L and the number of columns including the residual weight in the plurality of pruned large sub-matrices PSM_L, the first operation time and the second operation time can be synchronized. That is, the matrix multiplication system MMS may adjust the sum of the number of rows of the first processing element array 240_S and the number of columns including the residual weights in the plurality of pruned small sub-matrices in PSM_S to be the same as the sum of the number of rows of the plurality of second processing element array 240_L and the number of columns including the residual weight in the pruned large sub-matrices PSM_L through the above-described S1000 to S4000. However, the scope of the disclosure is not limited thereto.

FIG. 26 and FIG. 27 illustrate an operation of a matrix pruning device according to another embodiment. First, referring to FIG. 1, FIG. 3, and FIG. 26, a matrix pruning device 100 may generate a plurality of pruning groups PG. The matrix pruning device 100 may calculate group importance of each of the plurality of pruning groups PG. For example, the matrix pruning device 100 may calculate group importance of each of the first pruning group PG1 to the fourth pruning group PG4. The matrix pruning device 100 may classify each of the plurality of pruning groups PG into as an important pruning group IPG and an unimportant pruning groups UIPG based on the group importance of each of the plurality of pruning groups PG. The method by which the matrix pruning device 100 classifies each of the plurality of pruning groups PG as the important pruning group IPG and the unimportant pruning groups UIPG is similar to the method described with reference to FIG. 3, and therefore no further detailed description will be provided.

The matrix pruning device 100 may generate a plurality of small sub-matrices SM_S based on the plurality of important pruning groups IPG. For example, the matrix pruning device 100 may generate a plurality of small sub-matrices SM_S by splitting each of the plurality of important pruning groups IPG into two or more small sub-matrices SM_S. For a more detailed example, the matrix pruning device 100 may split the first pruning group PG1 by row to generate a first small sub-matrix SM_1 and a second small sub-matrix SM_2. Similarly, the matrix pruning device 100 may generate a third small sub-matrix SM_3 and a fourth small sub-matrix SM_4 by splitting the fourth pruning group PG4 by row.

In other words, the matrix pruning device 100 may generate a small sub-matrix SM_S by splitting one pruning group PG.

The matrix pruning device 100 may generate a plurality of large sub-matrices SM_L based on the plurality of unimportant pruning groups UIPG. For example, the matrix pruning device 100 may generate one large sub-matrix SM_L based on one unimportant pruning group UIPG. For example, referring to FIG. 27, the second pruning group PG2 may be transformed into a first large sub-matrix SM_L1 and the third pruning group PG3 may be transformed into a second large sub-matrix SM_L2.

For example, referring to the embodiment of FIG. 26 and FIG. 27, similar to the embodiment described with reference to FIG. 3, the important pruning group IPG may be transformed into a sub-matrix of a relatively small size, and the unimportant pruning groups UIPG may be transformed into a sub-matrix of a relatively large size. In this case, since the important pruning group IPG may be pruned relatively finely, errors due to pruning of the weight matrix WM (e.g., operation errors of the artificial intelligence model including the matrix multiplication system MMS) can be minimized.

FIG. 28 is a block diagram of a matrix multiplication system according to an embodiment. Referring to FIG. 1 to FIG. 28, the matrix multiplication system MMS may include a matrix pruning device 300 and a matrix multiplication device 400.

The matrix pruning device 300 may receive the weight matrix WM. The matrix pruning device 300 may generate the plurality of pruned small sub-matrices PSM_S, the plurality of pruned medium sub-matrices PSM_M, and the plurality of pruned large sub-matrices PSM_L based on the weight matrix WM.

The number of rows included in each of the plurality of pruned medium sub-matrices PSM_M may be greater than the number of rows included in each of the plurality of pruned small sub-matrices PSM_S and smaller than the number of rows included in each of the plurality of pruned large sub-matrices PSM_L.

The total number of rows included in the plurality of pruned small sub-matrices PSM_S, the plurality of pruned medium sub-matrices PSM_M, and the plurality of pruned large sub-matrices PSM_L may be equal to the number of rows of the weight matrix WM.

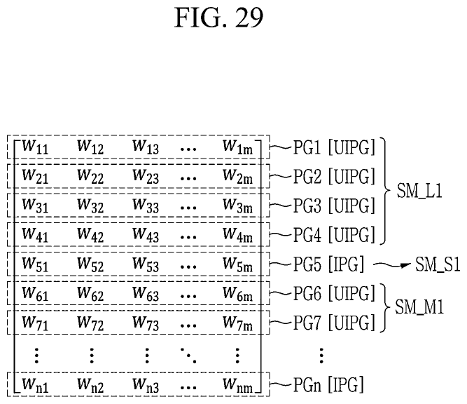

For example, the matrix pruning device 300 may generate three types of pruned sub-matrices based on the weight matrix WM. However, the disclosure is not limited thereto, and as such, according to another embodiment, the matrix pruning device 300 may generate more than three types of pruned sub-matrices based on the weight matrix WM. The operation of the matrix pruning device 300 will be described in more detail with reference to FIG. 29.

The matrix multiplication device 400 may receive the input matrix XM. The matrix multiplication device 400 may generate the output matrix YM based on the product of the plurality of pruned small sub-matrices PSM_S, the plurality of pruned medium sub-matrices PSM_M, and the plurality of pruned large sub-matrices PSM_L.

FIG. 29 illustrates the operation of the matrix pruning device of FIG. 28. Referring to FIG. 1 to FIG. 28, the matrix pruning device 300 may generate a first pruning group PG1 to an n-th pruning group PGn based on the weight matrix WM. Hereinafter, for a more concise description, an embodiment in which the matrix pruning device 300 generates one pruning group for each row of the weight matrix WM is described, but the scope of the disclosure is not limited thereto. For example, similar to the way described with reference to FIG. 3, the matrix pruning device 300 may generate one pruning group for each two rows of the weight matrix WM.

The matrix pruning device 300 may calculate group importance of each of the first pruning group PG1 to the n-th pruning group PGn. The matrix pruning device 300 may classify each of the first pruning group PG1 to the n-th pruning group PGn into an important pruning group IPG and an unimportant pruning group UIPG based on group importance of each of the first pruning group PG1 to the n-th pruning group PGn. For example, the matrix pruning device 300 may classify a fifth pruning group PG5 as the important pruning group IPG, and the first to fourth pruning groups PG1 to PG4 and sixth to seventh pruning groups PG6 to PG7 as the unimportant pruning groups UIPG.

The matrix pruning device 300 may generate a plurality of small sub-matrices SM_S based on the plurality of pruning groups classified into the important pruning group IPG. The method of generating for the matrix pruning device 300 to generate the plurality of small sub-matrices SM_S based on the plurality of pruning groups classified into the important pruning group IPG is similar to the method described with reference to FIG. 3, and therefore no further description will be provided.

The matrix pruning device 300 may generate the plurality of medium sub-matrices SM_M and the plurality of large sub-matrices SM_L based on the plurality of pruning groups classified into the unimportant pruning groups UIPG. In this case, the number of pruning groups included in each of the plurality of medium sub-matrices SM_M may be greater than the number of pruning groups included in each of the plurality of small sub-matrices SM_S and smaller than the number of pruning groups included in each of the plurality of large sub-matrices SM_L. For example, the number of pruning groups included in each of the plurality of small sub-matrices SM_S may be 1, the number of pruning groups included in each of the plurality of medium sub-matrices SM_M may be 2, and the number of pruning groups included in each of the plurality of large sub-matrices SM_L may be 4.

Next, the matrix pruning device 300 may generate the plurality of pruned small sub-matrices PSM_S by pruning the plurality of small sub-matrices SM_S, may generate the plurality of pruned medium sub-matrices PSM_M by pruning the plurality of medium sub-matrices SM_M, and may generate the plurality of pruned large sub-matrices PSM_L by pruning the plurality of large sub-matrices SM_L. The method for the pruning device 300 to prune the sub-matrix is similar to the method described with reference to FIG. 4 and FIG. 5, and therefore a detailed description will be omitted.

In an embodiment, the matrix pruning device 300 may generate a plurality of medium sub-matrices SM_M by merging two adjacent unimportant pruning groups UIPG, and may generate a plurality of large sub-matrices SM_L by merging four adjacent unimportant pruning groups UIPG. However, the scope of the disclosure is not limited thereto. For example, the matrix pruning device 300 may classify the first to n-th pruning group PG1 to PGn to an important pruning group, a middle-important pruning group, and an unimportant pruning group based on group importance information of the first to n-th pruning group PG1 to PGn respectively. In this case, the matrix pruning device 300 may be implemented to generate a plurality of small sub-matrices based on the plurality of important pruning group, generate a plurality of medium sub-matrices based on the plurality of middle-important pruning group, and generate a plurality of large sub-matrices based on the plurality of unimportant pruning group. For example, the matrix pruning device 300 may generate a plurality of small sub-matrices based on the plurality of important pruning group having group importance higher than a first group importance threshold value, generate a plurality of medium sub-matrices based on the plurality of middle-important pruning group having group importance higher than a second group importance threshold value and lower than the second group importance threshold value, and generate a plurality of large sub-matrices based on the plurality of unimportant pruning group having group importance lower than the second group importance threshold value. In other words, the scope of the disclosure is not limited to the specific manner in which the matrix pruning device 300 generates sub-matrices of different sizes. Although the terms “higher than” or “lower than” is used to classify the pruning groups, the disclosure is not limited thereto, and as such, according to another embodiment, other combinations of “equal to or higher than”, “equal to or lower than”, etc. may be used to classify the pruning groups.

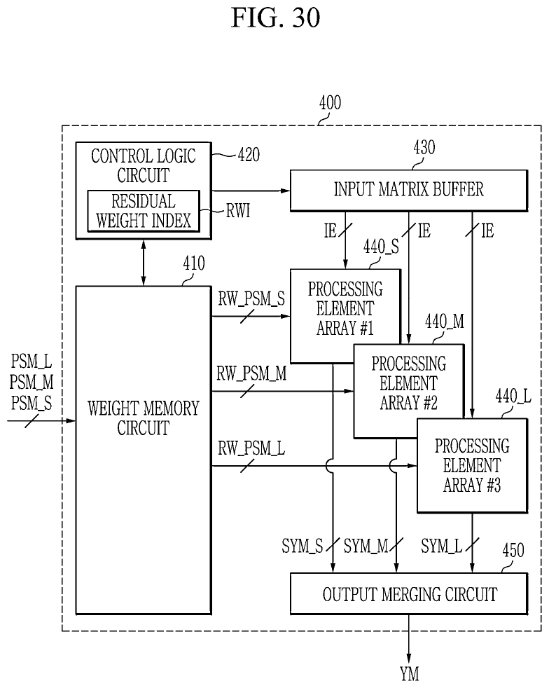

FIG. 30 is a block diagram illustrating the matrix multiplication device of FIG. 28 in more detail. Referring to FIG. 1 to FIG. 30, the matrix multiplication device 400 may include a weight memory circuit 410, a control logic circuit 420, an input matrix buffer 430, a first processing element array 440_S, a second processing element array 440_M, a third processing element array 440_L, and an output merging circuit 450. The configuration and function of the weight memory circuit 410, the control logic circuit 420, the input matrix buffer 430, and the output merging circuit 450 are similar to those previously described with reference to FIG. 6, and therefore no further detailed description will be provided.

The first processing element array 240_S may receive residual weights RW_PSM_S included in the plurality of pruned small sub-matrices PSM_S. The first processing element array 240_S may receive a plurality of input elements IE corresponding to residual weights RW_PSM_S. The first processing element array 240_S may generate a plurality of small sub-output matrix SYM_S based on the residual weights RW_PSM_S and the received input elements IE.

The second processing element array 240_M may receive residual weights RW_PSM_M included in a plurality of pruned medium sub-matrices PSM_M. The second processing element array 240_M may receive a plurality of input elements IE corresponding to residual weights RW_PSM_M. The second processing element array 240_M may generate a plurality of medium sub-output matrices SYM_M based on the residual weights RW_PSM_M and the received input elements IE.

The third processing element array 240_L may receive residual weights RW_PSM_L included in a plurality of pruned large sub-matrices PSM_L. The third processing element array 240_L may receive a plurality of input elements IE corresponding to the residual weights RW_PSM_L. The third processing element array 240_L may generate a plurality of large sub-output matrices SYM_L based on the residual weights RW_PSM_L and the received input elements IE.

In an embodiment, the number of columns of each of the first processing element array 240_S, the second processing element array 240_M, and the third processing element array 240_L may be the same.

In an embodiment, the number of rows of the first processing element array 240_S may be the same as the number of rows of the plurality of pruned small sub-matrices PSM_S. The number or rows of the second processing element array 240_M may be the same as the number or rows of the plurality of pruned medium sub-matrices PSM_M. The number or rows of the third processing element array 240_L may be the same as the number of rows of the plurality of pruned large sub-matrices PSM_L.

The output merging circuit 450 may generate an output matrix YM by merging the plurality of small sub-output matrices SYM_S, the plurality of medium sub-output matrices SYM_M, and the plurality of large sub-output matrices SYM_L.

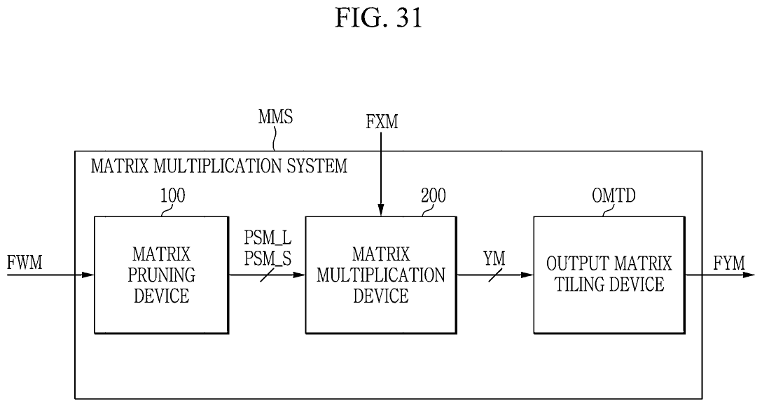

FIG. 31 illustrates the matrix multiplication system of FIG. 1 according to an embodiment. Referring to FIG. 1 to FIG. 31, the matrix multiplication system MMS may include a matrix pruning device 100, a matrix multiplication device 200, and an output matrix tiling device OMTD.

The matrix pruning device 100 may receive a full-weight matrix FWM. The full-weight matrix FWM may include the weight matrix WM described previously with reference to FIG. 1 to FIG. 30. For example, the full-weight matrix FWM may include a plurality of weight matrices WM.

The matrix pruning device 100 may generate a plurality of pruned small sub-matrices PSM_S and a plurality of pruned large sub-matrices PSM_L based on each of the plurality of weight matrices WM included in the full-weight matrix FWM.

The matrix multiplication device 200 may receive a full-input matrix FXM. Referring to FIG. 1 to FIG. 30, the full-input matrix FXM may include the input matrix XM previously described with reference to FIG. 1 to FIG. 30.

The matrix multiplication device 200 may generate a plurality of output matrices YM based on the plurality of pruned small sub-matrices PSM_S and the plurality of pruned large sub-matrices PSM_L. For example, the matrix multiplication device 200 may generate the plurality of output matrices YM to result of multiplying each of plurality of pruned small sub-matrices PSM_S and plurality of pruned large sub-matrices PSM_L by one corresponding input matrix XM.

The output matrix tiling device OMTD may receive the plurality of output matrices YM. The output matrix tiling device OMTD may generate a full-output matrix FYM corresponding to the product of the full-weight matrix FWM and the full-input matrix FXM based on the plurality of output matrices YM.

That is, the matrix system MMS may perform matrix multiplication for the full-input matrix FXM and the full-weight matrix FWM through one of various tiling techniques. In other words, the matrix system MMS may generate a full-output matrix FYM by sequentially obtaining the product of the plurality of input matrices XM and the plurality of weight matrices WM and then combining the obtained results.

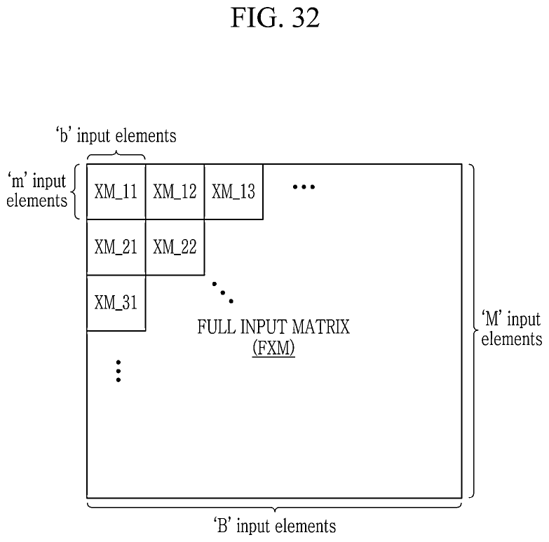

FIG. 32 illustrates the full-input matrix of FIG. 31. Referring to FIG. 1 to FIG. 32, the full-input matrix FXM may include a plurality of input matrices XM. In other words, the full-input matrix FXM may be tiled with a plurality of input matrices XM arranged in a row direction and a column direction. Hereinafter, for a more concise description, an input matrix arranged in an (i)-th row and a (j)-th column of the full-input matrix FXM may be referred to as “XM_ij”.

In an embodiment, the input matrix XM described with reference to FIG. 1 to FIG. 30 may be one of the plurality of input matrices XM included in the full-input matrix FXM.

In an embodiment, each of the plurality of input matrices XM included in the full-input matrix FXM may have the same row size and column size. For example, each of the plurality of input matrices XM may include b input elements per row. Each of the plurality of input matrices XM may include m input elements per column.

The row size of the full-input matrix FXM may be an integer multiple of the plurality of row sizes of each input matrix XM. For example, one row of the full-input matrix FXM may contain B input elements. In this case, B may be integer times of b.

The column size of the full-input matrix FXM may be an integer times the column size of each of the plurality of the input matrices XM. For example, one column of the full-input matrix FXM may include M input elements. In this case, M may be integer times of m.

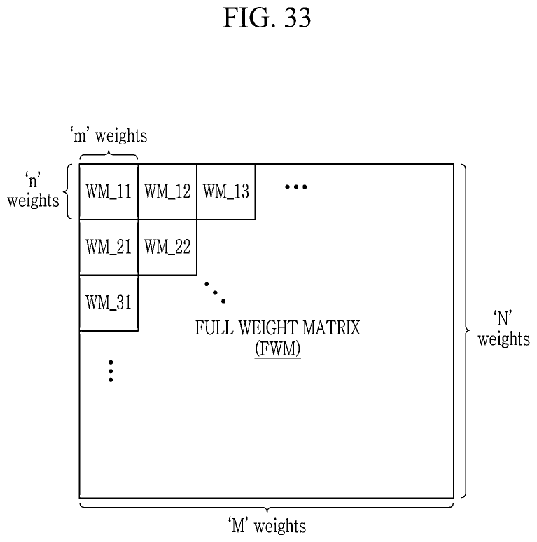

FIG. 33 illustrates the full-weight matrix of FIG. 31. Referring to FIG. 1 to FIG. 33, the full-weight matrix FWM may include a plurality of weight matrices WM. In other words, the full-weight matrix FWM may be tiled into a plurality of weight matrices WM arranged in the row direction and the column direction. Hereinafter, for a more concise description, a weight matrix arranged in an (i)-th row and a (j)-th column the full-weight matrix FWM may be referred to as “WM_ij”.

In an embodiment, the weight matrix WM previously described with reference to FIG. 1 to FIG. 30 may be one of the plurality of weight matrices WM included in the full-weight matrix FWM.

In an embodiment, each of the plurality of weight matrices WM included in the full-weight matrix FWM may have the same row size and column size. For example, each of the plurality of weight matrices WM may include m weights per row. Each of the plurality of weight matrices WM may include n weights per column.

The row size of the full-weight matrix FWM may be integer times the row size of each of the plurality of weight matrices WM. For example, m weights may be included in one row of the full-weight matrix FWM. In this case, M may be integer times of m.

The column size of the full-weight matrix FWM may be integer times the row size of each of the plurality of weight matrices WM. For example, N weights may be included in one column of the full-weight matrix FWM. In this case, N may be integer times of n.

The matrix pruning device 100 may generate the plurality of pruned small sub-matrices PSM_S and the plurality of pruned large sub-matrices PSM_L based on each of the plurality of weight matrices WM included in the full-weight matrix FWM. In this case, a plurality of pruned small sub-matrices PSM_S and a plurality of pruned large sub-matrices PSM_L generated based on a weight matrix WM_11 may be different from a plurality of pruned small sub-matrices PSM_S and a plurality of pruned large sub-matrices PSM_L generated based on a weight matrix WM_12. A method for the matrix pruning device 100 to generate the plurality of pruned small sub-matrices PSM_S and the plurality of pruned large sub-matrices PSM_L based on each of the weight matrices WM is similar to the method described with reference to FIG. 1 to FIG. 30, and therefore no further detailed description will be provided.

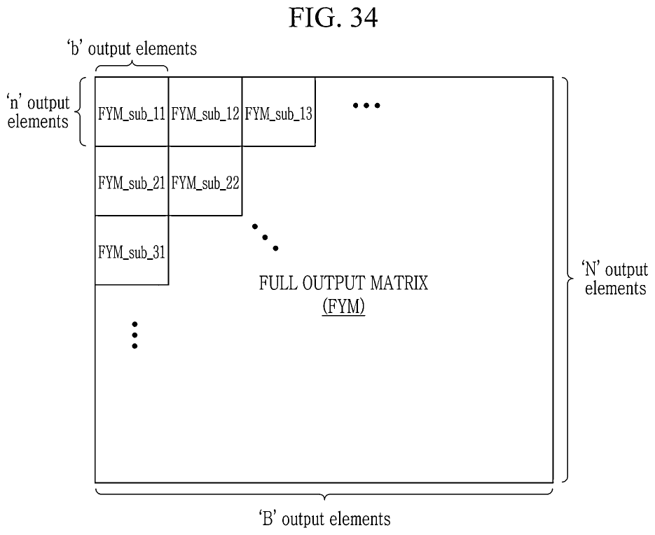

FIG. 34 illustrates the full-output matrix of FIG. 31. Referring to FIG. 1 to FIG. 34, the full-output matrix FYM may correspond to the product of the full-weight matrix FWM and the full-input matrix FXM.

The full-output matrix FYM may include a plurality of sub-matrices FYM_sub arranged in the row direction and the column direction. Hereinafter, for a more concise description, a sub-matrix arranged in an (i)-th row and a (j)-th column of the full-output matrix FYM may be referred to as FYM_sub_ij.

Each of the plurality of sub-matrices FYM_sub may have the same row size and column size. The column size of each of the plurality of sub-matrices FYM_sub may be the same as the column size of weight matrix WM. The row size of each of the plurality of sub-matrices FYM_sub may be the same as the row size of input matrix XM. For example, each of the plurality of sub-matrices FYM_sub may have b output elements per row. Each of the plurality of sub-matrices FYM_sub may include n output elements per column.

The row size of the full-output matrix FYM may be the same as the row size of the full-input matrix FXM. For example, the row size of the full-output matrix FYM may be B.

The column size of the full-output matrix FYM may be the same as the column size of the full-weight matrix FWM. For example, the column size of the full-output matrix FYM may be N.

The matrix multiplication system MMS may calculate the full-output matrix FYM with sub-matrix FYM_sub unit. For example, the matrix multiplication system MMS may calculate one sub-matrix FYM_sub by adding the products of the plurality of input matrices XM and the plurality of weight matrices WM.

For a more detailed example, in a case in which M is three times of m, the matrix multiplication device 200 may sequentially calculate a first output matrix corresponding to the product of the weight matrix WM_11 and the input matrix XM_11, a second output matrix corresponding to the product of the weight matrix WM_12 and the input matrix XM_21, and a third output matrix corresponding to the product of the weight matrix WM_13 and the input matrix XM_31. In this case, the output matrix tiling device OMTD may calculate a sub-matrix FYM_sub_11 by adding the first to third output matrices. In this way, the output matrix tiling device OMTD may be able to generate the full-output matrix FYM by sequentially obtaining the plurality of sub-matrices FYM_sub.

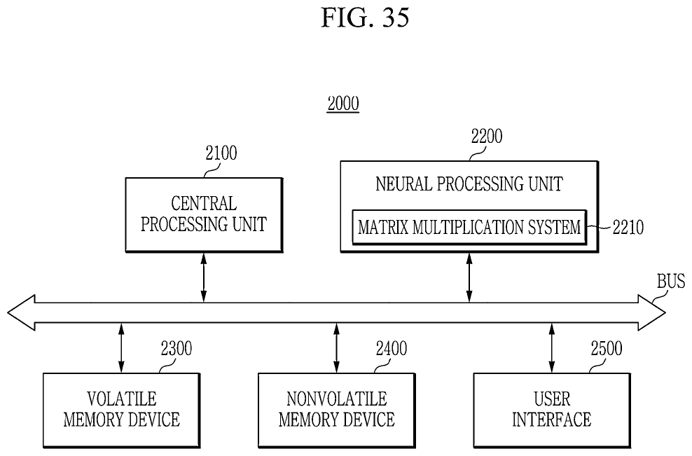

FIG. 35 is a block diagram of a neural processing system implemented according to an embodiment. Referring to FIG. 35, a neural processing system 2000 may include a central processing unit (CPU) 2100, a neural processing unit (NPU) 2200, a volatile memory device 2300, a nonvolatile memory device 2400, and a user interface 2500. The CPU 2100, the NPU 2200, the volatile memory device 2300, the nonvolatile memory device 2400, and the user interface 2500 may be connected with each other through a bus BUS.

The CPU 2100 may control overall operations of the neural processing system 2000. For example, the CPU 2100 may control each component of the neural processing system 2000 to run an artificial intelligence model.

In an embodiment, the artificial intelligence model executed by the neural processing system 2000 may be one of any type of artificial intelligence model, such as a language model, an image identification model, an image generation model, a weather analysis model, and the like. For example, the artificial intelligence model executed by the neural processing system 2000 may be one of any type of artificial intelligence model such as GPT-3, GPT-4, Pangu, GShard, Megatron-LM, and the like. However, the scope of the disclosure is not limited thereto.

In an embodiment, the artificial intelligence model executed by the neural processing system 2000 may perform inference operations and/or training operations. However, the scope of the scope disclosure is not limited thereto.

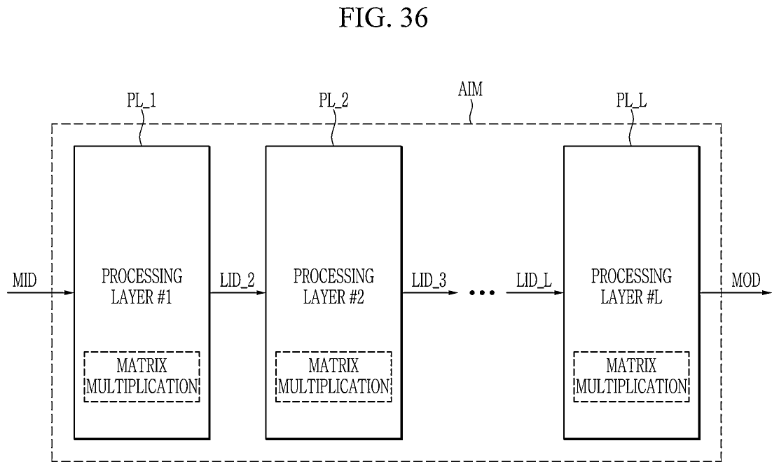

Each artificial intelligence model may include a plurality of processing layers. Each of the plurality of processing layers may be implemented to generate ‘layer output data’ by receiving ‘layer input data’. In this case, the generated layer output data may be used as layer input data of other processing layer. For example, layer output data generated from a first processing layer may be used as layer input data for a second processing layer. A more detailed description for the artificial intelligence model and the processing layer will be provided with reference to FIG. 36.

Each of the plurality of processing layers may transform layer input data into layer output data based on a matrix multiplication operation. For example, each of the plurality of processing layers may generate an output matrix corresponding to layer output data by multiplying an input matrix corresponding to the layer input data by a weight matrix. However, the scope of disclosure is not limited thereto, and each of the plurality of processing layers may be able to generate layer output data by transforming the input matrix corresponding to the layer input data in an any scheme. For example, each of the plurality of processing layers may be implemented to transform an input matrix into layer output data based on any conversion parameters. In other words, the scope of the disclosure is not limited to the specific manner in which each of the plurality of processing layers transforms layer input data.

The NPU 2200 may include a matrix multiplication system 2210. The matrix multiplication system 2210 may execute at least a part of operations included in the plurality of processing layer. For example, the matrix multiplication system 2210 may perform a matrix multiplication operation included in the plurality of processing layers.

In an embodiment, the matrix multiplication operation may account for most of a processing load required by the neural processing system 2000 to execute each of plurality of processing layers.

In an embodiment, the matrix multiplication system 2210 may be implemented as matrix multiplication system MMS described above with reference to FIG. 1 to FIG. 30. For example, the matrix multiplication system 2210 may include a matrix pruning device 100. In this case, the matrix multiplication system 2210 may generate a plurality of pruned small sub-matrices PSM_S and a plurality of pruned large sub-matrices PSM_L based on a weight matrix WM splitted into a plurality of pruning groups PG. In this case, since the weight matrix WM may be pruned considering the importance of each of the plurality of pruning groups PG, an error of an output matrix generated by the matrix multiplication system 2210 can be minimized. Therefore, according to the embodiment of the disclosure, the operation speed of the artificial intelligence model can be improved because a high pruning ratio can be applied to weights of low importance and a low pruning ratio can be applied to weights of high importance, and therefore the decreasing in operational accuracy of the intelligence model can be minimized.

In an embodiment, the matrix multiplication system 2210 may be implemented as the matrix multiplication system MMS described above with reference to FIG. 1 to FIG. 30. For example, the matrix multiplication system 2210 may include a matrix multiplication device 200. In this case, the matrix multiplication system 2210 may calculate the product of the input matrix for each of the plurality of pruned small sub-matrices PSM_S using a first processing element array 240_S, and may calculate the product of the input matrix for each of the plurality of pruned large sub-matrices PSM_L using a second processing element array 240_L. In this case, the product operations may be performed on matrices with different sizes depending on the sizes of the first processing element array 240_S and the second processing element array 240_L, and therefore the operation efficiency of the matrix multiplication system 2210 can be maximized.

The volatile memory device 2300 may be used as an operation memory of the NPU 2200. For example, the volatile memory device 2300 may temporarily store data generated during operation of the NPU 2200.

In an embodiment, the NPU 2200 may access the volatile memory device 2300 to execute operations included in the plurality of processing layers. For example, the NPU 2200 may be implemented to read parameters stored in the volatile memory device 2300 and perform an operation on layer input data, or may be implemented to temporarily store intermediate data generated during the operation in the volatile memory device 2300.

In an embodiment, the volatile memory device 2300 may be implemented with any type of volatile memory, such as a dynamic random access memory (DRAM) or a static random access memory (SRAM).

In an embodiment, the volatile memory device 2300 may be used as a buffer memory, an operation memory, or a cache memory of the CPU 2100. However, the scope of the disclosure is not limited thereto

The nonvolatile memory device 2400 may store data for the operation of the neural processing system 2000. For example, the nonvolatile memory device 2400 may store various types of data, such as an operating system (OS) of the neural processing system 2000 or parameters for running an artificial intelligence model. However, the scope of the disclosure is not limited thereto

The CPU 2100 may communicate with a user through the user interface 2500. The CPU 2100 may provide model input data provided by the user to the volatile memory device 2300 or the NPU 2200 through the user interface 2500. The CPU 2100 may return model output data generated by the artificial intelligence model based on model input data to the user through the user interface 2500.

FIG. 36 is a block diagram of the artificial intelligence model run by the neural processing system of FIG. 35. Referring to FIG. 35 and FIG. 36, the neural processing system 2000 may run an artificial intelligence model AIM.

The artificial intelligence model AIM may receive model input data MID. The artificial intelligence model AIM may include a plurality of processing layers PL_1 to PL_L.

The artificial intelligence model AIM may generate model output data MOD by sequentially transforming the model input data MID through the first to L-th processing layers PL_1 to PL_L. For example, the first processing layer PL_1 may receive the model input data MID and generate second layer input data LID_2. The second processing layer PL_2 may receive the second layer input data LID_2 and generate third layer input data LID_3. In this way, the L-th processing layer PL_L may receive L-th layer input data LID_L and generate model output data MOD.

Each of the first to L-th processing layers PL_1 to PL_L may transform the received data to data to be output through various types of operations. For example, a matrix multiplication operation may be included in the operations performed by the first processing layer PL_1 to transform the model input data MID into the second layer input data LID_2. Similarly, each of the first to L-th processing layers PL_1 to PL_L may need to perform a matrix multiplication operation to transform the received layer input data. However, the scope of disclosure is not limited thereto, and some of the first to L-th processing layers PL_1 to PL_L may not perform matrix multiplication operations.

In an embodiment, the matrix multiplication operation performed by each of the first to L-th processing layers PL_1 to PL_L may be performed through the matrix multiplication system 2210.

In an embodiment, in a case in which the matrix multiplication system 2210 is implemented as the matrix multiplication system MMS described above with reference to FIG. 1 to FIG. 30, the matrix multiplication system 2210 may be able to output results of matrix multiplication operations with higher accuracy and higher speed. Therefore, according to the embodiment of the disclosure, the operating speed of the artificial intelligence model AIM can be improved.

For a more concise explanation, in FIG. 36, an embodiment consisting of a plurality of processing layers in which the artificial intelligence model AIM operates in series is representatively described, but the scope of the disclosure is not limited thereto. For example, the artificial intelligence model AIM may further include processing layers that operate in parallel with at least some of the first to L-th processing layers PL_1 to PL_L described above. In other words, the scope of disclosure is not limited to the specific implementation method of the artificial intelligence model AIM.

The contents described above are specific embodiments for implementing disclosure. The disclosure will include not only the above-described embodiments, but also embodiments that have simply changed design or can be easily modified. In addition, the disclosure will also include technologies that can be easily modified and implemented using embodiments. Therefore, the scope of the disclosure should not be limited to the above-described embodiments and should be determined by the scope of patent claims described later as well as those equivalent to the scope of patent claims of the disclosure.

What is claimed is:

1. A matrix multiplication device comprising:
a weight memory circuit configured to store a first pruned sub-matrix comprising a first plurality of residual weights and a second pruned sub-matrix comprising a second plurality of residual weights;
an input matrix buffer configured to:
receive an input matrix comprising a plurality of input elements,
output a first plurality of input elements among the plurality of input elements, corresponding to the first plurality of residual weights, and
output a second plurality of input elements among the plurality of input elements, corresponding to the second plurality of residual weights;
a first processing element array configured to:
receive the first plurality of residual weights and the first plurality of input elements, and
output a first sub-output matrix; and
a second processing element array configured to:
receive the second plurality of residual weights and the second plurality of input elements, and
output a second sub-output matrix.

2. The matrix multiplication device of claim 1, wherein:
a number of columns of the first pruned sub-matrix is the same as a number of columns of the second pruned sub-matrix, and
a number of rows of the second pruned sub-matrix is n times a number of rows of the first pruned sub-matrix, n being an integer.

3. The matrix multiplication device of claim 2, wherein:
the first processing element array comprises a first plurality of processing elements arranged in a row direction and a column direction,
the second processing element array comprises a second plurality of processing elements arranged in the row direction and the column direction,
a number of rows of the first processing element array is the same as a number of rows of the first pruned sub-matrix,
a number of rows of the second processing element array is the same as a number of rows of the second pruned sub-matrix, and
a number of columns of the first processing element array is the same as a number of columns of the second processing element array.

4. The matrix multiplication device of claim 1, wherein:
the first pruned sub-matrix further comprises a first plurality of zero elements, and the first plurality of residual weights and the first plurality of zero elements are arranged in different columns of the first pruned sub-matrix, and
the second pruned sub-matrix further comprises a second plurality of zero elements, and the second plurality of residual weights and the second plurality of zero elements are arranged in different columns of the second pruned sub-matrix.

5. The matrix multiplication device of claim 4, wherein the input matrix buffer is configured to:
output the first plurality of input elements based on first residual weight indexes indicating a first plurality of column numbers including the first plurality of residual weights in the first pruned sub-matrix, and
output the second plurality of input elements based on a second residual weight indexes indicating a second plurality of column numbers including the second plurality of residual weights in the second pruned sub-matrix.

6. The matrix multiplication device of claim 5, wherein:
the first plurality of input elements are arranged in a first plurality of input element rows in the input matrix,
the first plurality of residual weights are arranged in a first plurality of columns in the first pruned sub-matrix,
row numbers of the first plurality of input element rows in the input matrix correspond to column numbers of the first plurality of columns in the first pruned sub-matrix,
the second plurality of input elements are arranged in a second plurality of input element rows in the input matrix,
the second plurality of residual weights are arranged in a second plurality of columns in the second pruned sub-matrix, and
row numbers of the second plurality of input element rows in the input matrix correspond to column numbers of the second plurality of columns in the second pruned sub-matrix.

7. The matrix multiplication device of claim 1, wherein:
the weight memory circuit is further configured to:
store a first plurality of pruned sub-matrices including the first pruned sub-matrix, and
store a second plurality of pruned sub-matrices including the second pruned sub-matrix,
the first processing element array is further configured to generate a first plurality of sub-output matrices each corresponding to a product of the input matrix and one of the first plurality of pruned sub-matrices, and
the second processing element array is further configured to generate a second plurality of sub-output matrices each corresponding to a product of the input matrix and one of second plurality of pruned sub-matrices.

8. The matrix multiplication device of claim 7, wherein:
a first operation time for generating the first plurality of sub-output matrices by the first processing element array corresponds to a second operation time for generating the second plurality of sub-output matrices by the second processing element array.

9. The matrix multiplication device of claim 8, wherein, based on a number of the first plurality of pruned sub-matrices and a number of the second plurality of pruned sub-matrices being the same, a time for generating the first sub-output matrix by the first processing element array is the same as a time for generating the second sub-output matrix by the second processing element array.

10. The matrix multiplication device of claim 8, wherein:
among the first plurality of residual weights, two or more first residual weights arranged in a same row of the first pruned sub-matrix are stored in continuous addresses in the weight memory circuit, and
among the second plurality of residual weights, two or more second residual weights arranged in a same row of the second pruned sub-matrix are stored in continuous addresses in the weight memory circuit.

11. The matrix multiplication device of claim 1, further comprising:
an output merging circuit configured to:
generate an output matrix based on the first sub-output matrix and the second sub-output matrix.

12. A matrix multiplication system comprising:
a matrix pruning device generating a first plurality of pruned sub-matrices and a second plurality of pruned sub-matrices based on a weight matrix; and
a matrix multiplication device comprising:
a first processing element array configured to generate a first plurality of sub-output matrices based on an input matrix and the first plurality of pruned sub-matrices,
a second processing element array configured to generate a second plurality of sub-output matrices based on the input matrix and the second plurality of pruned sub-matrices, and
an output merging circuit configured to generate an output matrix based on the first plurality of sub-output matrices and the second plurality of sub-output matrices.

13. The matrix multiplication system of claim 12, wherein:
a number of columns of each of the first plurality of pruned sub-matrices and the second plurality of pruned sub-matrices is a first number,
a number of rows of each of the first plurality of pruned sub-matrices is a second number, and
a number of rows of each of the second plurality of pruned sub-matrices is a third number, which is n times of the second number, n being an integer.

14. The matrix multiplication system of claim 13, wherein:
a number of columns of the first processing element array and the second processing element array is the first number,
a number of rows of the first processing element array is the second number, and
a number of rows of the second processing element array is the third number.

15. The matrix multiplication system of claim 14, wherein:
the matrix pruning device is further configured to generate, based on the weight matrix, a third plurality of pruned sub-matrices comprising rows of a fourth number and columns of the first number, the fourth number being m times the second number, where m is an integer,
the matrix multiplication device further comprises a third processing element array configured to generate a third plurality of sub-output matrices based on the input matrix and the third plurality of pruned sub-matrices,
the output merging circuit is further configured to generate the output matrix further based on the third plurality of sub-output matrices, and
the fourth number is smaller than the third number.

16. The matrix multiplication system of claim 12, wherein:
a first operation time for generating the first plurality of sub-output matrices by the first processing element array corresponds to a second operation time for generating the second plurality of sub-output matrices by the second processing element array.

17. The matrix multiplication system of claim 16, wherein, based on the first operation time and the second operation time, the matrix pruning device is further configured to determine a number of columns including residual weight of each of the first plurality of pruned sub-matrices and a number of columns including a residual weight of each of the second plurality of pruned sub-matrices.

18. The matrix multiplication system of claim 16, wherein:
based on the first operation time and the second operation time, the matrix pruning device is further configured to determine a number of the first plurality of pruned sub-matrices and a number of the second plurality of pruned sub-matrices.

19. An operation method of a matrix multiplication device comprising:
generating a plurality of pruning groups by splitting a weight matrix;
classifying the plurality of pruning groups as a first plurality of pruning groups and a second plurality of pruning groups based on group importance of each of the plurality of pruning groups;
generating a first plurality of sub-matrices based on the first plurality of pruning groups;
generating a second plurality of sub-matrices based on the second plurality of pruning groups;
generating a first plurality of pruned sub-matrices by pruning each of the first plurality of sub-matrices;
generating a second plurality of pruned sub-matrices by pruning each of the second plurality of sub-matrices; and
generating an output matrix based on products of an input matrix and each of the first plurality of pruned sub-matrices and the second plurality of pruned sub-matrices.

20. The operation method of claim 19, wherein:
each of the first plurality of sub-matrices corresponds to one of the first plurality of pruning groups, and
each of the second plurality of sub-matrices corresponds to two or more of the second plurality of pruning groups.
